(19) United States
(12) Patent Application Publication
(10) Pub. No.: US 2009/0322905 A1
(43) Pub. Date: Dec. 31, 2009

(54) Storage control device

(75) Inventors: Toshiharu Matsuda, Soka-shi (JP); Naoki Yamagata, Shiki-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/385,697

(22) Filed: Apr. 16, 2009

(30) Foreign Application Priority Data
Jun. 25, 2008 (JP) 2008-165937
Jul. 11, 2008 (JP) 2008-180916

(51) Int. Cl. H04N 5/76

(52) U.S. Cl. 348/231.99; 348/E09.002

(57) ABSTRACT

A storage control device includes: a memory where a data file is temporarily stored; a read-out unit that sequentially reads out divided data segments of the data file; a storage medium that includes data storage areas having small areas and data management areas each corresponding to the small area, so as to store each of the data segments into small areas and store at least one of first link information and second link information into the data management areas; a first instruction unit that issues an instruction for procuring consecutive data management areas corresponding to a data size of data segments; a second instruction unit that issues an instruction for writing the first link information into the data management areas excluding a trailing-end data management area; and a third instruction unit that issues an instruction for sequentially writing the data segment into the data storage areas.

### INCORPORATION BY REFERENCE

The disclosures of the following priority applications are herein incorporated by reference:
Japanese Patent Application No. 2008-165937 filed Jun. 25, 2008
Japanese Patent Application No. 2008-180916 filed Jul. 11, 2008

### BACKGROUND OF THE INVENTION

1. Field of the Invention

The present invention relates to a storage control device under control by which data are recorded for storage in a storage medium.

2. Description of Related Art

Today, an electronic device such as a digital camera is typically used in conjunction with a storage medium constituted with a memory card or a memory stick loaded therein. The storage media used in such applications include rewritable storage media and write-once storage media into which data can be written only once. It is to be noted that Japanese Laid Open Patent Publication No. 2007-18528 and Japanese Laid Open Patent Publication No. 2003-196142 each disclose a file management technology that may be adopted in conjunction with write-once storage media.

### SUMMARY OF THE INVENTION

The storage medium loaded in the digital camera as described above, e.g., a memory card, is normally formatted by adopting the FAT (file allocation table) filing system. Files recorded into data storage areas are managed based upon file management information referred to as “FAT” in the FAT filing system. The FAT is constituted with FAT entries each corresponding to a data storage area allocated to a given cluster. In the FAT entry for a given cluster in which file data are stored, the cluster number corresponding to the cluster to be read out next, following the given cluster, is recorded to indicate the order with which final data are read out, and in the FAT entry corresponding to the cluster which is to be read out last, a terminating end symbol is recorded.

In order to record data originating at a host device such as a PC or a digital camera into a storage medium, e.g., a memory card, adopting such a FAT filing system, the host device first temporarily stores the recording-target file data into its internal memory. The host device procures specific clusters by referencing the FAT each time data in the internal memory are to be recorded into the storage medium. Then, the host device records the read-out order and the terminating end symbol in the FAT entries corresponding to the clusters having been procured, and records the data into the clusters.

A data file with content such as movie image, the file size of which cannot be estimated while the recording session is in progress, is stored in a plurality of installments. Under such circumstances, the host device needs to update the FAT entries each time an installment of data is recorded so that the FAT entry terminating end symbol for the file data is set in the FAT entry corresponding to the very last cluster of data among the clusters of data having been written thus far. In addition, the host device needs to update the FAT entries by resetting the terminating end symbol each time an installment of data is recorded, as described above, when a given set of file data are stored in a plurality of installments so as to, for instance, allow another type of processing to interrupt the recording of the file data in progress.

However, the terminating end symbol having been recorded in the FAT entry corresponding to the current last cluster cannot be reset when recording file data such as movie data expressing, for instance, a movie image, the volume of which is greater than the capacity of the internal memory, into a write-once type storage medium, giving rise to the following problem. Namely, if the read-out order and the terminating end symbol are recorded in the FAT entries each time file data stored in the internal memory are recorded, the single set of file data cannot be stored in a plurality of installments.

According to the 1st aspect of the present invention, a storage control device comprises: a memory in which a data file is temporarily stored; a read-out unit that sequentially reads out data segments obtained by dividing the data file stored in the memory into equal data segments matching a predetermined unit; a storage medium that includes data storage areas made up with a plurality of small areas all assuming a predetermined size and a plurality of data management areas each corresponding to one of the plurality of small areas, so as to store each of the data segments into small areas and store at least one of first link information and second link information into the data management areas, the first link information indicating a read-out order with which the data segments stored in the small areas are to be read out and the second link information indicating an end of the read of the data segments; a first instruction unit that issues an instruction for procuring a plurality of consecutive data management areas in correspondence to a data size of data segments having been read out by the read-out unit; a second instruction unit that issues an instruction for writing the first link information into the data management areas excluding a trailing-end data management area among the procured data management areas; and a third instruction unit that issues an instruction for sequentially writing the data segment having been read out by the read-out unit into the data storage areas corresponding to the procured data management areas.

According to the 2nd aspect of the present invention, it is preferred that the storage control device according to the 1st aspect further comprises: a fourth instruction unit that issues an instruction for writing the second link information into the trailing-end data management area among the data management areas procured in correspondence to the data size of the data segment read out last among all the data segments in the data file.

According to the 3rd aspect of the present invention, it is preferred that the storage control device according to the 1st aspect further comprises a fourth instruction unit that issues an instruction for writing the second link information into the trailing-end data management area among the procured data management areas if a write error occurs while the data segment is being written into the data storage areas, and in the storage control device, the read-out unit reads out the data file stored in the memory again in the data segments all matching the predetermined unit; the first instruction unit issues an instruction for re-procuring the data management areas in correspondence to the data size of each data segment having been read out again; the second instruction unit issues an instruction for writing the first link information into the data management areas excluding the trailing-end data management area among the re-procured data management areas; and the third instruction unit issues an instruction for writing the data segment having been read again into the data storage areas corresponding to the re-procured data management areas.

According to the 4th aspect of the present invention, it is preferred that in the storage control device according to the 3rd aspect, if a data storage area where the write error has occurred corresponds to the trailing-end data management area among the procured data storage areas, the fourth instruction unit issues an instruction for writing the second link information into the trailing-end data management area among the procured data management areas; if the data storage area where the write error has occurred does not correspond to the trailing-end data management area among the procured data management areas, the read-out unit reads out the data file stored in the memory again in the predetermined unit; the first instruction unit issues an instruction for re-procuring the data management areas corresponding to data storage areas succeeding the data storage area where the write error has occurred; the second instruction unit issues an instruction for writing the first link information into the data management areas excluding the trailing-end data management area among the re-procured data management areas; and the third instruction unit issues an instruction for writing each data segment having been read out again into the data storage areas corresponding to the re-procured data management areas.

According to the 5th aspect of the present invention, it is preferred that the storage control device according to the 4th aspect further comprises a fifth instruction unit that issues an instruction for recording a data file read-out start position at which read of the data file to be stored in the data storage areas starts, into a specific data storage area, and in the storage control device, the fourth instruction unit issues an instruction for writing the second link information into the trailing-end data management area among the data management areas re-procured in correspondence to the data size of the last data segment having been read out again among all the data segments in the data file; and the fifth instruction unit issues an instruction for writing into the specific data storage area information on the data storage area at which a write of the data segments having been read out again starts as information indicating the data file read-out start position.

According to the 6th aspect of the present invention, the storage control device according to the 1st aspect may further comprise: a decision-making unit that makes a decision as to whether a storage medium is a write-once storage medium or a non-write-once-type storage medium and a fourth instruction unit that issues an instruction for writing the second link information into the trailing-end data management area among the data management areas procured in correspondence to the data size of the data segment each time a data segment is read out, if a storage medium is judged to be a non-write-once storage medium.

According to the 7th aspect of the present invention, a storage control device comprises: a memory in which a data file is temporarily stored; a read-out unit that sequentially reads out data segments obtained by dividing the data file stored in the memory into equal data segments matching a predetermined unit; a storage medium that includes data storage areas made up with a plurality of small areas all assuming a predetermined size and a plurality of data management areas each corresponding to one of the plurality of small areas, so as to store each of the data segments into small areas and store at least one of first link information and second information into the data management area, the first link information indicating a read-out order with which the data segments stored in the small areas are to be read out second link information indicating an end of the read of the data segments; a first instruction unit that issues an instruction for procuring a plurality of consecutive data management areas in correspondence to a data size of data segments having been read out by the read-out unit and a subsequent data management area following the consecutive data management areas; a second instruction unit that issues an instruction for writing the first link information in the data management areas excluding a trailing-end data management area among the procured data management areas; and a third instruction unit that issues an instruction for sequentially writing the data segment, having been read out by the read-out unit into the data storage areas corresponding to the data management areas in which the first link information has been written, excluding the trailing-end data management area.

According to the 8th aspect of the present invention, the storage control device according to the 7th aspect may further comprise: a fourth instruction unit that issues an instruction for writing the second link information into the trailing-end data management area among the data management areas procured for the data segment read out last among all the data segments in the data file.

According to the 9th aspect of the present invention, it is preferred that the storage control device according to the 8th aspect further comprise a fifth instruction unit that issues an instruction for recording a data file read-out start position at which read of the data file to be stored in the data storage areas starts, into a specific data storage area, and in the storage control device, if a write error occurs while write of the data segment into the data storage areas corresponding to the procured data management areas is in progress; the read-out unit again reads out the data stored in the memory in the data segments all matching the predetermined unit; the first instruction unit issues an instruction for re-procuring the data management areas following the trailing-end data management area among the data management areas having been procured immediately before occurrence of the write error; the second instruction unit issues an instruction for writing the first link information into the data management areas excluding the trailing-end data management area among the re-procured data management areas; the third instruction unit issues an instruction for executing rewrite processing for writing again each data segment read out again into the data storage areas corresponding to the data management areas in which the first link information is written, excluding the trailing-end data management area among the re-procured data management areas; the fourth instruction unit issues an instruction for writing the second link information into the trailing-end data management area among the data management areas procured at an end of the rewrite processing executed for all the data segments in the data file; and the fifth instruction unit issues an instruction for writing information on the data storage area at which the rewrite processing starts into the specific data storage area as information indicating the data file read-out start position.

According to the 10th aspect of the present invention, it is preferred that the storage control device according to the 8th aspect further comprises a fifth instruction unit that issues an instruction for recording a data file read-out start position at which read of the data file to be stored in the data storage areas starts, into a specific data storage are at and in the storage control device, if a write error occurs while write of the data segment into the data storage areas corresponding to the procured data management areas is in progress; the first instruction unit issues an instruction for re-procuring the data management areas corresponding to the data storage areas succeeding a data storage area where the write error has occurred; the second instruction unit issues an instruction for writing the first link information into the data management areas excluding the trailing-end data management area among the re-procured data management areas; the third instruction unit issues an instruction for executing rewrite processing for writing again each data segment read out again into the data storage areas corresponding to the data management areas in which the first link information is written, excluding the trailing-end data management area among the re-procured data management areas; the fourth instruction unit issues an instruction for writing the second link information into the trailing-end data management area among the data management areas procured at an end of the rewrite processing executed for all the data segments in the data file; and the fifth instruction unit issues an instruction for writing information on the data storage area at which the rewrite processing starts into the specific data storage area as information indicating the data file read-out start position.

According to the 11th aspect of the present invention, it is preferred that the storage control device according to the 7th aspect further comprises: a decision-making unit that makes the decision as to whether a storage medium is a write-once-type storage medium or a non-write-once storage medium; and a fourth instruction unit that issues an instruction for writing the second link information into the trailing-end data management area among the data management areas procured for each data segment that is read out, if the storage medium is judged to be a non-write-once type storage medium.

### BRIEF DESCRIPTION OF THE DRAWINGS

FIG. 1 is a block diagram of the camera achieved in an embodiment;

FIG. 2 illustrates the configuration of the FAT filing system adopted in the embodiment;

FIG. 3 presents a flowchart of the camera operation executed in the embodiment;

FIG. 4 presents a flowchart of the image data record processing executed in the camera in the embodiment;

FIGS. 5A˜5C each present an example of a condition of the FAT filing system in the embodiment, with FIG. 5A showing the FAT filing system prior to image file recording, FIG. 5B showing the FAT filing system at the time of the first image data recording session and FIG. 5C showing the FAT filing system at the time of the second image data recording session;

FIGS. 6A˜6C each present an example of a condition of the FAT filing system in the embodiment, with FIG. 5A showing the FAT filing system at the time of the third image data recording session, FIG. 6B showing the FAT filing system at the time of the fourth image data recording session and FIG. 5C showing the FAT filing system at the image file recording end;

FIG. 7 presents a flowchart of the image data record processing executed in the camera in the embodiment;

FIGS. 8A˜8C each present an example of a condition of the FAT filing system in the embodiment, with FIG. 8A showing the FAT filing system prior to image file recording, FIG. 8B showing the FAT filing system at the time of the first image data recording session and FIG. 8C showing the FAT filing system at the time of the second image data recording session;

FIG. 9 presents a flowchart of the camera operation executed in a first variation;

FIGS. 10A and 10B each present an example of a condition of the FAT filing system in the first variation, with FIG. 10A showing the FAT filing system prior to image file recording and FIG. 10B showing the FAT filing system following a write error having occurred during an image data recording session;

FIGS. 11A˜11C each present an example of a condition of the FAT filing system in the first variation, with FIG. 11A showing the FAT filing system during the write error processing, FIG. 11B showing the FAT filing system at the time of the image data rewrite session executed following the error processing and FIG. 11C showing the FAT filing system at the image file recording end;

FIG. 12 presents a flowchart of the camera operation executed in a second variation;

FIGS. 13A˜13C each present an example of a condition of the FAT filing system in the second variation, with FIG. 13A showing the FAT filing system during the write error processing, FIG. 13B showing the FAT filing system at the time of the image data rewrite session executed following the error processing and FIG. 13C showing the FAT filing system at the image file recording end;

FIG. 14 presents a flowchart of the image data record processing executed in the camera in a second embodiment;

FIGS. 15A˜15C each present an example of a condition of the FAT filing system in the second embodiment, with FIG. 15A showing the FAT filing system prior to image file recording, FIG. 15B showing the FAT filing system at the time of the first image data recording session and FIG. 15C showing the FAT filing system at the time of the second image data recording session;

FIGS. 16A˜16C each present an example of a condition of the FAT filing system in the embodiment, with FIG. 16A showing the FAT filing system at the time of the third image data recording session, FIG. 16B showing the FAT filing system at the time of the fourth image data recording session and FIG. 16C showing the FAT filing system at the image file recording end;

FIG. 17 presents a flowchart of the camera operation executed in a third variation;

FIGS. 18A and 18B each present an example of a condition of the FAT filing system in the third variation, with FIG. 18A showing the FAT filing system prior to image file recording and FIG. 18B showing the FAT filing system following a write error having occurred during an image data recording session;

FIGS. 19A and 198 each present an example of a condition of the FAT filing system in the third variation, with FIG. 19A showing the FAT filing system at the time of the image data rewrite session executed after the occurrence of the error and FIG. 19B showing the FAT filing system at the image file recording end;

FIG. 20 presents a flowchart of the camera operation executed in a fourth variation; and

FIGS. 21A˜21C each present an example of a condition of the FAT filing system in the fourth variation, with FIG. 21A showing the FAT filing system at the time of a write error, FIG. 21B showing the FAT filing system at the time of the image data rewrite session executed following the occurrence of the error and FIG. 21C showing the FAT filing system at the image file recording end.

### DESCRIPTION OF PREFERRED EMBODIMENTS

### First Embodiment

The following is a description of a camera that includes the storage control device achieved in the first embodiment of the present invention. In reference to the embodiment, the processing executed in the camera to record a still image file containing a single still image, into a memory card in a plurality of installments is described.

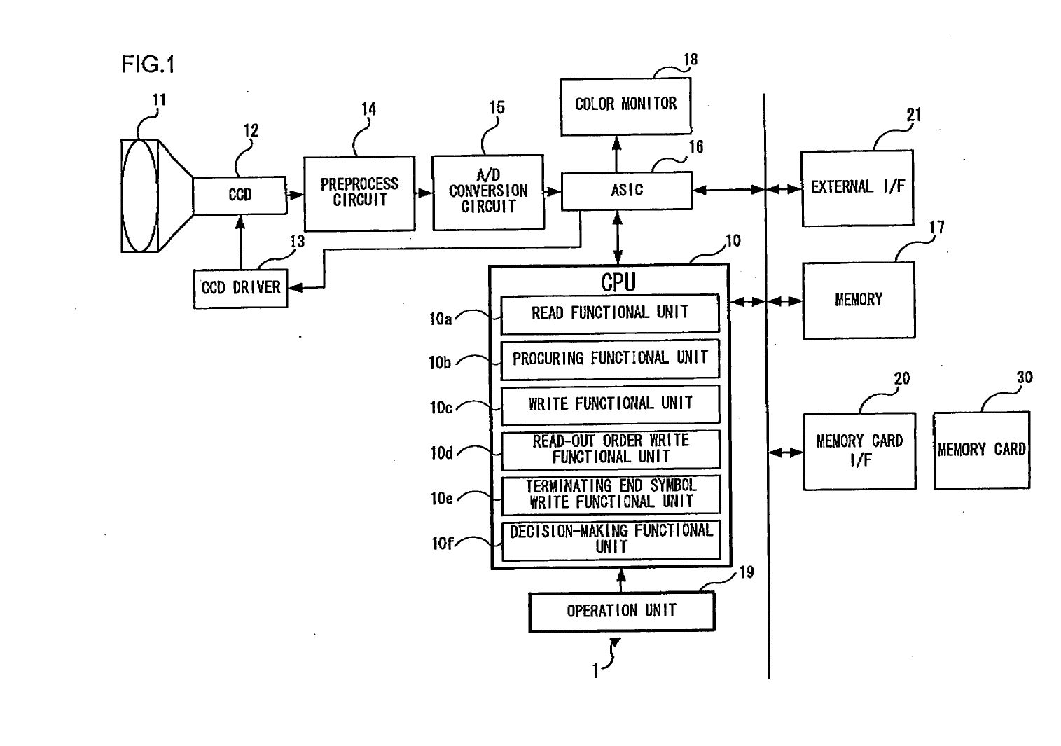

FIG. 1 is a block diagram showing the structure of the camera achieved in the first embodiment. As shown in the figure, the camera 1 includes a photographic lens 11, a CCD 12, a CCD driver 13, a preprocess circuit 14, an A/D conversion circuit 15, an ASIC (application-specific integrated circuit) 16, a memory 17, a color monitor 18, an operation unit 19, a memory card I/F 20, an external I/F 21 and a CPU 10.

The CCD 12 stores electrical charges corresponding to the brightness of a subject by capturing an image formed with the subject light via the photographic lens 11, and outputs analog signals constituted with the stored electrical charges to the preprocess circuit 14 under control executed by the CCD driver 13. The analog signals output from the CCD 12 are amplified at the preprocess circuit 14, which then executes analog processing such as noise removal and black level adjustment on the signals. The A/D conversion circuit 15 converts the analog signals having undergone the analog processing at the preprocess circuit 14 to digital signals. The ASIC 16 generates image data by executing image processing such as outline compensation and gamma correction on the digital signals resulting from the conversion at the A/D conversion circuit 15. The ASIC 16 also creates, in compliance with the exif (exchangeable image file format) standard header information data that include information indicating the image data photographing date, information indicating the shutter speed and compression information and thumbnail image data generated by reducing the image data having undergone the image processing to a predetermined size. The ASIC 16 then creates an image file by compressing the header information data, the thumbnail image data and the image data resulting from the image processing (hereafter referred to as “main image data”) in a specific format such as JPEG.

In the memory 17 constituted with a DRAM (dynamic random access memory) and used as a work area when the CPU 10 executes a program, the image data having undergone the image processing and the like are temporarily stored. At the color monitor 18 which is a liquid crystal display unit, images, camera setting information and the like are displayed. The operation unit 19 that includes operation buttons such as a power switch and a shutter release switch is a user operation interface.

The memory card I/F 20 is a connection interface via which a detachable memory card 30 is connected. Read/write commands, data and the like exchanged between the loaded memory card and the camera 1 are relayed via the memory card I/F 20. The external I/F 21 is a connection interface such as a USB via which a device such as a PC is connected. Communication between the connected device and the camera 1 is relayed via the external I/F 21.

The memory card 30 includes a flash memory where data are stored, a memory controller that executes control for data write or data read and a register where card attribute information is stored. In response to a read/write command transmitted from the camera 1 via the memory card I/F 20, the memory controller in the memory card 30 executes data write control or data read control. The card attribute information includes data write unit information and information indicating whether the card is a write-once medium or a non-write-once medium. The memory card 30 is formatted in a FAT filing system. It is to be noted that in response to a command received from the camera 1, the memory card 30 transmits a command response to the camera 1 and that it also transmits a data response to the camera 1 each time data are written. It is assumed that data are written into the memory card 30 in a three-cluster unit in the embodiment.

The CPU 10 controls the various units constituting the camera 1 by executing a program stored in a ROM (not shown). The CPU 10 issues a write command or a read command and enables data transfer between the camera and the memory card 30 by using the FAT filing system in the memory card 30. In response to the write command, an image file (data file) read-out from the memory 17 is written into the memory card 30 in compliance with the DCF standard, whereas in response to the read command, an image file stored in the memory card 30 is read out. It is to be noted that when writing image data contained in an image file stored in the memory 17 into the memory card 30, the CPU 10 reads out the image data over a plurality of separate segments and issues the write command each time a data segment is read out.

In addition, the CPU 10 is equipped with the following functional units; a read functional unit 10a, a procuring functional unit 10b, a write functional unit 10c, a read-out order write functional unit 10d, a terminating end symbol write functional unit 10e and a decision-making functional unit 10f. When recording the image data into the memory card 30 as described above, the read functional unit 10a divides the image data in the image file stored in the memory 17 into data segments each corresponding to a predetermined unit and reads out the individual data segments. The procuring functional unit 10b issues an instruction for procuring an area where at least either information indicating the data read-out order or information indicating the read-out end is to be written in the FAT filing system to be described later.

The write functional unit 10c issues an instruction for writing image data (a data segment) read out by the read functional unit 10a into a data storage area in the FAT filing system. In addition, the write functional unit 10c issues an instruction for writing file information indicating the image file name and the image file start position into a specific region of the data storage area when the read functional unit 10a ends the read of the image data in the image file from the memory 17. The read-out order write functional unit 10d issues an instruction for writing the information indicating the read-out order into the area having been procured in response to the instruction issued by the procuring functional unit 10b. The terminating end symbol write functional unit 10e issues an instruction for writing the information indicating the read-out end into the area having been procured in response to the instruction issued by the procuring functional unit 10b. The decision-making functional unit 10f makes a decision based upon the card attribute information obtained from the memory card 30 as to whether or not the memory card 30 is a write-once medium.

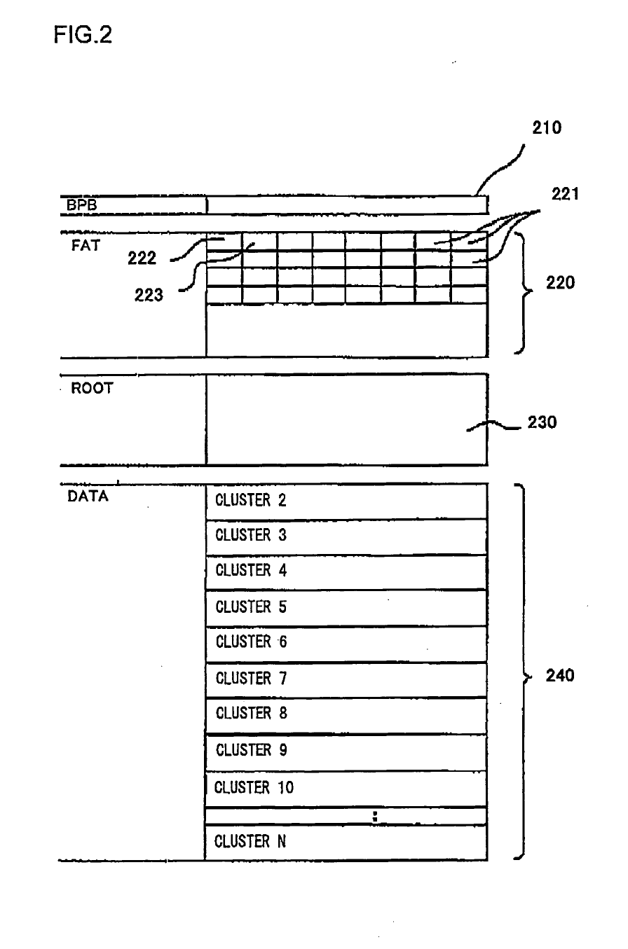

FIG. 2 shows the configuration of the FAT filing system described above. The FAT filing system is constituted with a BPB (Bios parameter block) 210, a FAT (file allocation table) 220, a file management area that includes a root 230 and a data storage area 240 that is managed in units of clusters, each of which includes a plurality of sectors. Namely, the data storage area 240 includes a plurality of small areas referred to as clusters. In the BPB 210, information indicating the number of sectors included in each cluster, and information indicating the number of bytes in each sector, information indicating the root directory size, information indicating the FAT type, e.g., FAT 16 or FAT 32, are stored.

In the root 230, the root directory folder name and the cluster number assigned to the cluster, in which the sub directory directly under the root directory is stored, are stored. Fat entries 221 in the FAT 220, each corresponding to one of the clusters in the data storage area 240, are set in the order matching the order with which the cluster numbers are assigned to the corresponding clusters. For instance, a FAT entry 222 corresponds to cluster 2, whereas FAT entry 223 corresponds to cluster 3. In addition, in each FAT entry 221, the cluster number assigned to the cluster to be read out after the corresponding cluster is stored to indicate the read-out order.

The data storage area 240 is made up with a plurality of clusters assigned with cluster numbers in ascending order, with the leading cluster assigned with cluster number “2”. File data such as JPEG data or raw data are stored in each cluster.

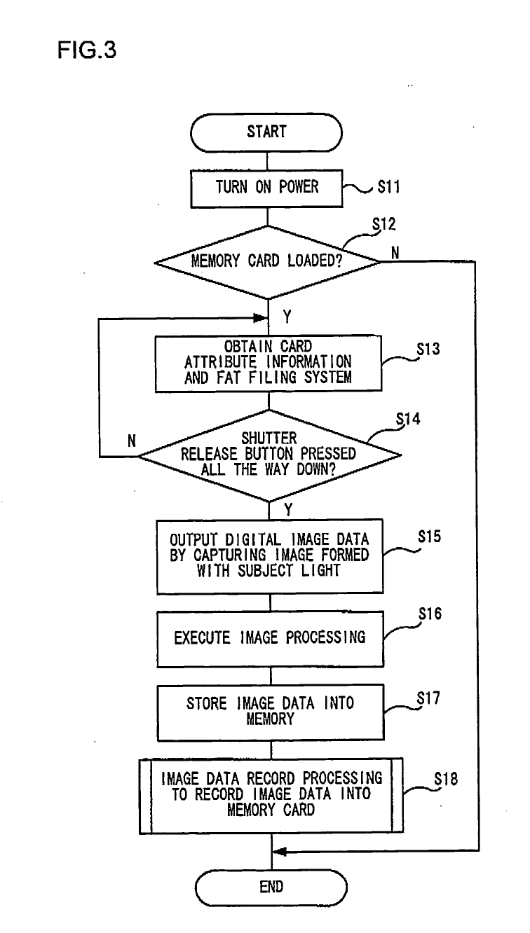

Next, the operation executed in the camera 1 is described in reference to the flowchart presented in FIG. 3. As the user operates the operation unit 19 to switch to a power ON state (step S11), the CPU 10 makes a decision as to whether or not the memory card 30 is loaded at the memory card I/F 20 (step S12).

If it is decided that the memory card 30 is not loaded at the memory card I/F 20 (step S12: N), the CPU 10 ends the processing. However, if it is judged that the memory card 30 is loaded (step S12: Y), the CPU 10 obtains the card attribute information and the FAT filing system from the memory card 30 and stores them into the memory 17 (step S13).

Upon deciding that the shutter release button at the operation unit 19 has been pressed all the way down by the user (step S14: Y), the CPU 10 generates image data based upon imaging signals output from the CCD 12 by capturing an image formed with the subject light and outputs the image data thus generated to the memory 17 (step S15). The ASIC 16 executes the image processing on the image data stored in the memory 17, generates thumbnail image data and compresses both the main image data and the thumbnail image data in the JPEG format (step S16). The CPU 10 stores image data that include the header information for the image frame and the compressed thumbnail image data and main image data into the memory 17 (step S17). The CPU 10 then executes processing for recording the single frame of image data, having been stored in the memory 17, into the memory card 30 (step S18).

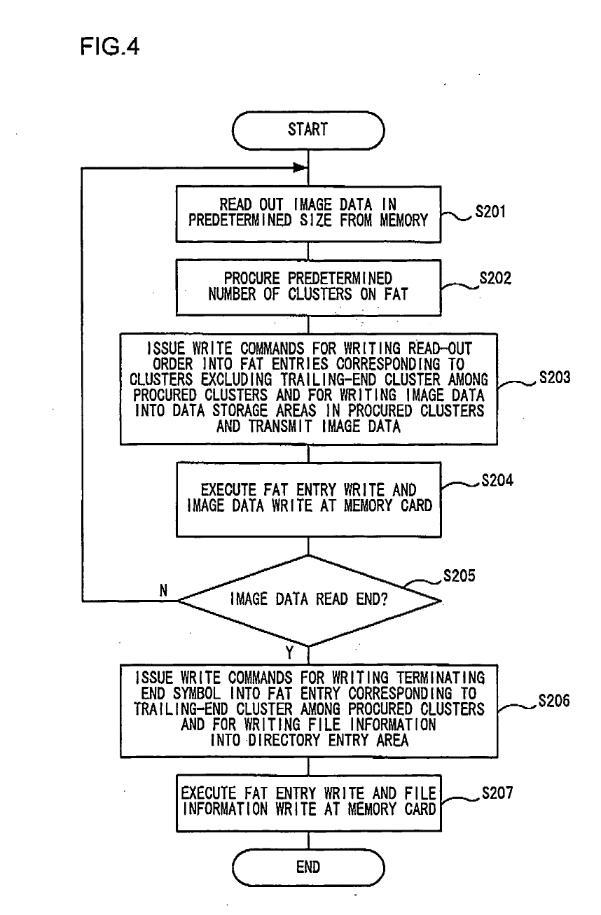

FIG. 4 presents a flowchart of the record processing in step S18, executed when the decision-making functional unit 10f determines that the memory card 30 is a write-once medium based upon the card attribute information having been obtained in step S13. The following description is given by assuming that the data write unit assumed in the memory card 30 is smaller than the storage capacity of the memory 17 and that the single frame of image data is recorded into the memory card 30 in a plurality of installments.

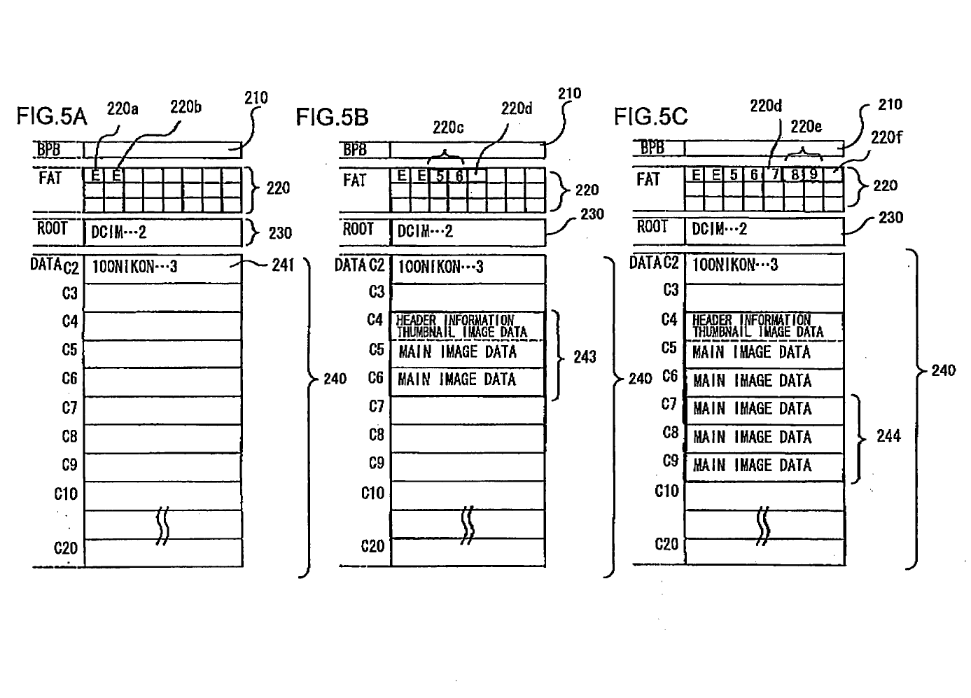

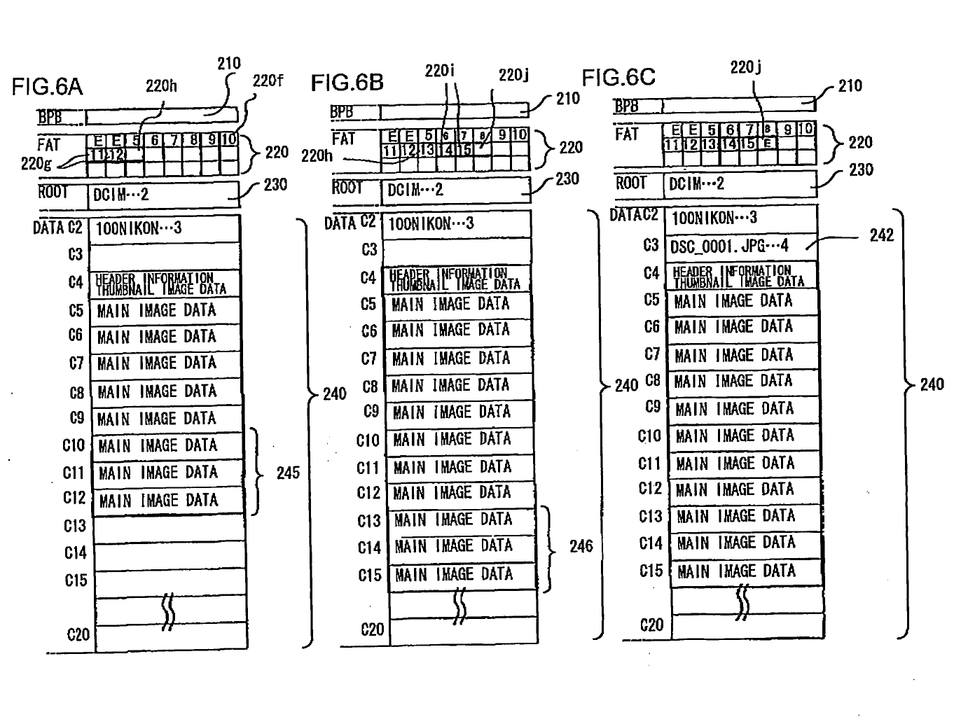

The read functional unit 10a reads out from the memory 17 image data (data segment) corresponding to three clusters constituting a single write unit by referencing the write units indicated in the card attribute information (step S201). FIGS. 5A˜5C and FIGS. 6A˜6C present examples of conditions of the FAT filing system in various stages, from the pre-record state in which the image file is yet to be recorded into the memory card 30, through the state in which the data in the image file have been recorded in four separate installments. The following is a description of the various steps in FIG. 4, given in reference to FIGS. 5A˜5C and FIGS. 6A˜6C.

FIG. 5A shows the FAT filing system having been read out in step S201. As shown in the figure, in the ROOT 230, a “DCIM” folder generated in compliance with the DCF standard is stored as the root directory and cluster number “2” assigned to cluster 2, in which the subdirectory directly under the DCIM is stored, is stored. In addition, the subdirectory “100 NIKON” having been generated in compliance with the DCF standard and cluster number “3” are stored in a data storage area 241 of cluster 2, assigned as the storage area for the sub directory directly under DCIM. Cluster number “3” indicates the directory entry area where the file information related to the image file stored under 100 NIKON is stored. In addition, the terminating end symbol “E” is stored both in FAT entries 220a and 220b corresponding to cluster 2 and cluster 3. It is assumed that the file information includes the file name and the starting cluster among the clusters in which the file is stored and that the image file is recorded directly under the subdirectory “100 NIKON”.

The procuring functional unit 10b procures clusters 4 through 6 making up a single write unit in the FAT 220. The read-out order write functional unit 10d then sequentially allocates the image data having been read out to the procured clusters 4 through 6. Namely, the read-out order write functional unit 10d sets cluster number “5” in the FAT entry of cluster 4 and cluster number “6” in the FAT entry of cluster 5 to indicate the read-out order (step S202). The read-out order write functional unit 10d issues a write command for writing the read-out order in the FAT entries excluding the FAT entry for the trailing-end cluster 6 among the procured clusters, i.e., in the FAT entries of clusters 4 and 5. The write functional unit 10c issues a write command as a form of instruction for writing the image data into the procured clusters 4 through 6. In addition, the write functional unit 10c transmits the image data having been read out to the memory card 30 (step S203).

Upon receiving the write commands and the image data via the memory card I/F 20, the memory card 30 transmits a command response to the camera 1. Based upon the received write commands, the memory card 30 writes the read-out order in the FAT entries and writes the image data sequentially starting at the leading sector in the data storage area corresponding to cluster 4. Subsequently, the memory card 30 transmits a data response via the memory card I/F 20 (step S204).

FIG. 5B shows the condition of the FAT filing system in the memory card 30 following the first image data read from the memory 17 (step S201) and the processing in steps S202˜S204 executed as described above. As shown in the figure, the read-out order is recorded in response to the write command issued by the read-out order write functional unit 10d in FAT entries 220c excluding a FAT entry 220d corresponding to the trailing-end cluster 6 among the procured clusters. The image file header information and thumbnail image data are recorded in data storage area 243 of cluster 4, whereas part of the main image data in the image file having been transmitted by the write functional unit 10c is recorded in data storage areas 243 of clusters 5 and 6.

Until the read functional unit 10a ends the image data read from the memory 17 (step S201), the CPU 10 repeatedly executes the processing in steps S201˜S204 so as to write data in the FAT entries and write the main image data in the three-cluster units in the memory card 30.

FIG. 5C shows the condition of the FAT filing system following the second image data read executed with the FAT filing system in the condition shown in FIG. 5B, the data write into FAT entries and the image data write into data storage areas. As shown in the figure, clusters 7˜9 are procured in response to an instruction issued by the procuring functional unit 10b as the second image data read is executed. The read-out order is recorded in FAT entries 220d and 220e excluding a FAT entry 220f corresponding to the trailing-end cluster 9 among the procured clusters in response to an instruction issued by the read-out order write functional unit 10d. The main image data transmitted via the write functional unit 10c are recorded in the data storage areas 224 of clusters 7 through 9.

FIG. 6A shows the condition of the FAT filing system following the third image data read executed with the FAT filing system in the condition shown in FIG. 5C, data write into FAT entries and the image data write into data storage areas. As shown in the figure, clusters 10˜12 are procured in response to an instruction issued by the procuring functional unit 10b as the third image data read is executed. The read-out order is recorded in FAT entries 220f and 220g excluding a FAT entry 220h corresponding to the trailing-end cluster 12 among the procured clusters in response to an instruction issued by the read-out order write functional unit 10d. The main image data transmitted via the write functional unit 10c are recorded in the data storage areas 245 of clusters 10 through 12.

FIG. 6B shows the condition of the FAT filing system following the fourth image data read is executed with the FAT filing system in the condition shown in FIG. 6A, the data write into FAT entries and the image data write into data storage areas. As shown in FIG. 6B, clusters 13˜15 are procured in response to an instruction issued by the procuring functional unit 10b as the fourth image data read is executed. The read-out order is recorded in FAT entries 220h and 220i excluding a FAT entry 220j corresponding to the trailing-end cluster 15 among the procured clusters, in response to an instruction issued by the read-out order write functional unit 10d. The main image data transmitted via the write functional unit 10c are recorded in the data storage areas 246 of clusters 13 through 15.

When the read of the image data in the image file from the memory 17 by the read functional unit 10a ends (step S205: Y), i.e., when the trailing-end data segment among the data segments constituting the image data has been read out, the terminating end symbol write functional unit 10e issues a write command. In response to this write command, the terminating end symbol is written in the FAT entry corresponding to the trailing-end cluster 15 among the most recently procured clusters. In addition, the write functional unit 10c issues a write command, in response to which the image file name “DSC_{—}0001.JPG” and the starting cluster number “4” are written as file information of cluster 3 designated as the directory entry area (step S206). The write commands issued in step S206 are received at the memory card 30 via the memory card I/F 20 and then the memory card 30 transmits a command response via the memory card I/F 20. In conformance to the received write commands, the terminating end symbol is written in the FAT entry corresponding to cluster 15 and the file information indicating the file name “DSC_{—}0001.JPG” and the starting cluster number “4” is written into the data storage area of cluster 3 at the memory card 30. The memory card 30 then transmits the data response via the memory card I/F 20 (step S207).

FIG. 6C. shows that the FAT filing system assumes the condition in which after the FAT filing system assumes the condition shown in FIG. 6B the image data read from the memory 17 ends (step S205: Y) and the processing in steps S206 and S207 is executed as explained earlier. As shown in the figure, the file information indicating the image file name “DSC_{—}0001.JPG” and the starting cluster number “4” are recorded in the data storage area 242 as the trailing-end cluster 3 in the memory card 30.

It is to be noted that the CPU 10 disallows issuance of a write command for other main image data while the main image data are being written into the write-once-type memory card 30. As a result, since no terminating end symbol is written in the FAT entry corresponding to the trailing-end cluster among the most recently procured clusters until the read ends, it is ensured that any single FAT entry is never used twice for the write of the read-out order corresponding to a set of main image data and the write of the read-out order corresponding to another set of main image data.

By reading out the file information in the directory entry area and the FAT entries in FIG. 6C, the CPU 10 is able to read out the data in the various data storage areas corresponding to clusters 4˜15 in sequence with the correct read-out order. As a result, the CPU 10 is able to reproduce the image corresponding to the image file “DSC_{—}0001.JPG”.

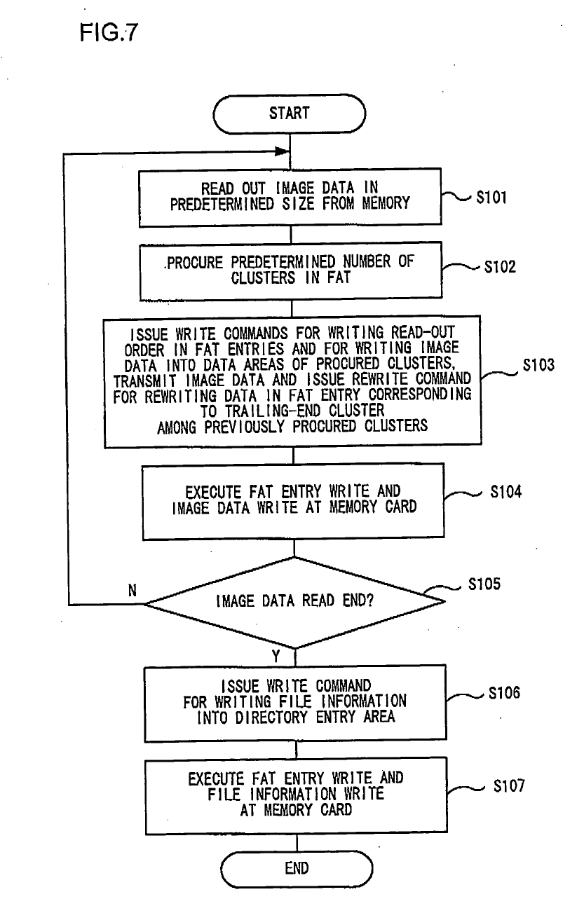

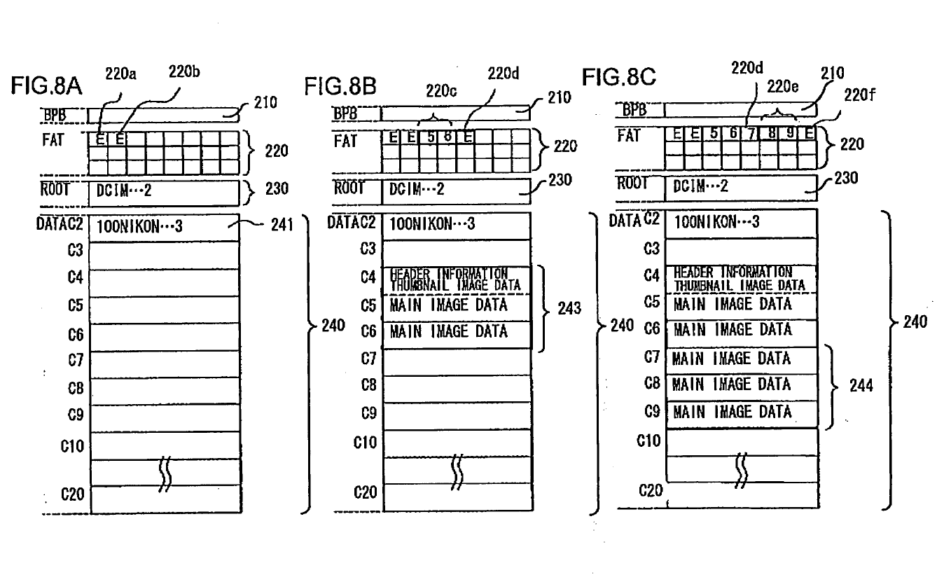

FIG. 7 presents a flowchart of the record processing in step S18 in FIG. 3, executed when the decision-making functional unit 10f in the CPU 10 determines that the memory card 30 is not a write-once medium (that it is a non-write-once medium) based upon the card attribute information having been obtained in step S13. After the memory card 30 is judged to be a non-write-once type storage medium, the read functional unit 10a reads out from the memory 17 image data (data segment) corresponding to three clusters constituting a single write unit by referencing the write unit indicated in the card attribute information (step S101). FIGS. 8A˜8C present examples of conditions of the FAT filing system in various stages, from the pre-record state in which the image file is yet to be recorded into the memory card 30, through the state in which the data in the image file have been recorded in two separate installments. The following is a description of the various steps in FIG. 7, given in reference to FIGS. 8A˜8C.

FIG. 8A shows the FAT filing system having been read out in step S101. As shown in the figure, in the ROOT 230 a “DCIM” folder generated in compliance with the DCF standard is stored as the root directory and cluster number “2” assigned to the cluster, in which the subdirectory directly under the DCIM is stored, is stored. In addition, the subdirectory “100 NIKON” having been generated in compliance with the DCF standard and cluster number “3” are stored in the data storage area 241 of cluster 2, in which the sub directory directly under DCIM is stored. Cluster number “3” indicates the directory entry area where the file information related to the image file stored under 100 NIKON is stored. The terminating end symbol “E” is stored in the FAT entries 220a and 220b corresponding to cluster 2 and cluster 3. It is assumed that the file information includes the file name and the starting cluster among the clusters in which the file is stored and that the image file is recorded directly under the subdirectory “100 NIKON”.

The procuring functional unit 10b procures clusters corresponding to a single write unit (clusters 4˜6 for the first write session) in the FAT 220. The read-out order write functional unit 10d sequentially allocates the image data having been read out to the procured clusters. It is to be noted that in the case of the first write session, the read-out order write functional unit 10d sets cluster number “5” in the FAT entry of cluster 4 and cluster number “6” in the FAT entry of cluster 5, whereas the terminating end symbol write functional unit 10e sets the terminating end symbol “E” in the FAT entry of cluster 6. Through this process, the read-out order write functional unit 10d sets the read-out order and the terminating end symbol write functional unit 10e sets the terminating end symbol in the FAT entry corresponding to the last cluster (step S102). The read-out order write functional unit 10d issues a write command for writing the read-out order in the specific FAT entries among the FAT entries corresponding to the procured clusters. The terminating end symbol write functional unit 10e issues a write command for writing the terminating end symbol in the FAT entry corresponding to the trailing-end cluster among the procured clusters. The write functional unit 10c issues a write command for writing the image data having been read out in step S101 into the data storage areas of the clusters having been set as described above. The write functional unit 10c also transmits the image data having been read out to the memory card 30 (step S103).

It is to be noted that if the current write session is not the first write session, the read-out order write functional unit 10d issues the following write command. Namely, it issues a command for rewriting the terminating end symbol written in the FAT entry corresponding to the last cluster among the clusters having been procured for the preceding write so as to replace it with the cluster number indicating the leading cluster for the current write session (e.g., in the case of the second write session, the terminating end symbol “E” in the FAT entry of cluster 6 is replaced with cluster number “7”).

Upon receiving the write commands and the image data via the memory card I/F 20, the memory card 30 transmits a command response to the camera 1. Based upon the received write commands, the memory card 30 writes the read-out order in the FAT entries and writes the image data sequentially starting at the leading sector in the data storage area corresponding to cluster 4. Subsequently, the memory card 30 transmits a data response via the memory card I/F 20 (step S104).

FIG. 8B shows the condition of the FAT filing system in the memory card 30 following the first image data read from the memory 17 (step S101) and the processing in steps S102˜S104 executed as described above. As shown in the figure, the read-out order is recorded in the FAT entries 220c excluding the FAT entry 220d corresponding to the trailing-end cluster 6 among the procured clusters and the terminating end symbol is recorded in the trailing-end cluster. The image file header information and the thumbnail image data are recorded in the data storage area 243 of cluster 4, whereas part of the main image data in the image file is recorded into the data storage areas 243 of clusters 5 and 6.

As long as the image data read from the memory 17 by the read functional unit 10a is still underway (step S105: N), the CPU 10 repeatedly executes the processing in steps S101˜S104 so as to write data in the FAT entries and the main image data in the three-cluster unit at the memory card 30.

FIG. 8C shows the condition of the FAT filing system following the second image data read executed with the FAT filing system in the condition shown in FIG. 8B, the data write into FAT entries and the image data write into data storage areas. As shown in the figure, clusters 7˜9 are procured as the second image data read is executed and the read-out order is recorded in the FAT entries 220d and 220e. The main image data are recorded in the data storage areas 224 of clusters 7 through 9.

When the read of the image data in the image file from the memory 17 by the read functional unit 10a ends (step S105: Y), the write functional unit 10c issues a write command (step S106). In response to this write command, the image file name “DSC_{—}0001.JPG” and the starting cluster number “4” assigned to the starting cluster 4 among the clusters in which the image file is stored, are written as the file information of cluster 3 designated as the directory entry area. The write command issued in step S107 is received at the memory card 30 via the memory card I/F 20 and the memory card 30 then transmits a command response via the memory card I/F 20. In conformance to the received write command, the file information indicating the file name “DSC_{—}0001.JPG” and the starting cluster number “4” is written into the data storage area of cluster 3 at the memory card 30. The memory card 30 then transmits a data response via the memory card I/F 20 (step S107).

FIG. 8C shows that the FAT filing system assumes the condition in which after the FAT filing system assumes the condition shown in FIG. 8B, the image data read from the memory 17 ends (step S105: Y) and the processing in steps S106 and S107 is executed as explained earlier. As shown in the figure, the terminating end symbol “E” is recorded in the FAT entry 220j corresponding to the trailing-end cluster 15, and the file information indicating the image file name “DSC_{—}0001.JPG” and the starting cluster number “4” is recorded in the data storage area 242 of cluster 3 in the memory card 30.

Thus, by reading out the file information in the directory entry area and the FAT entries in FIG. 8C, the CPU 10 is able to read out the data in the various data storage areas corresponding to clusters 4˜15 in sequence with the correct read-out order. As a result, the CPU 10 is able to reproduce the image corresponding to the image file “DSC_{—}0001.JPG”.

In the first embodiment described above, control is executed so as not to enter the terminating end symbol in the FAT entry corresponding to the trailing-end cluster among the clusters procured in the FAT for each write session until the write of the image data in the image file is completed even though the image data is recorded into a write-once type memory card in a plurality of installments. Under the control executed in the embodiment, image data contained in a given file can be recorded in a plurality of successive installments.

Next, variations of the first embodiment explained above are described.

First Variation

The first embodiment is described above by assuming that no write error occurs while the write of the image data into the memory card 30 is in progress. Now, in reference to this particular variation, error processing that may be executed after a write error occurs in the memory card 30 is described. It is to be noted that components identical to those in the first embodiment are referred to by quoting the same reference numerals. In addition, the variation is described by assuming that in the event of a write error in the memory card 30, the memory card 30 transmits a write error event message to the camera 1.

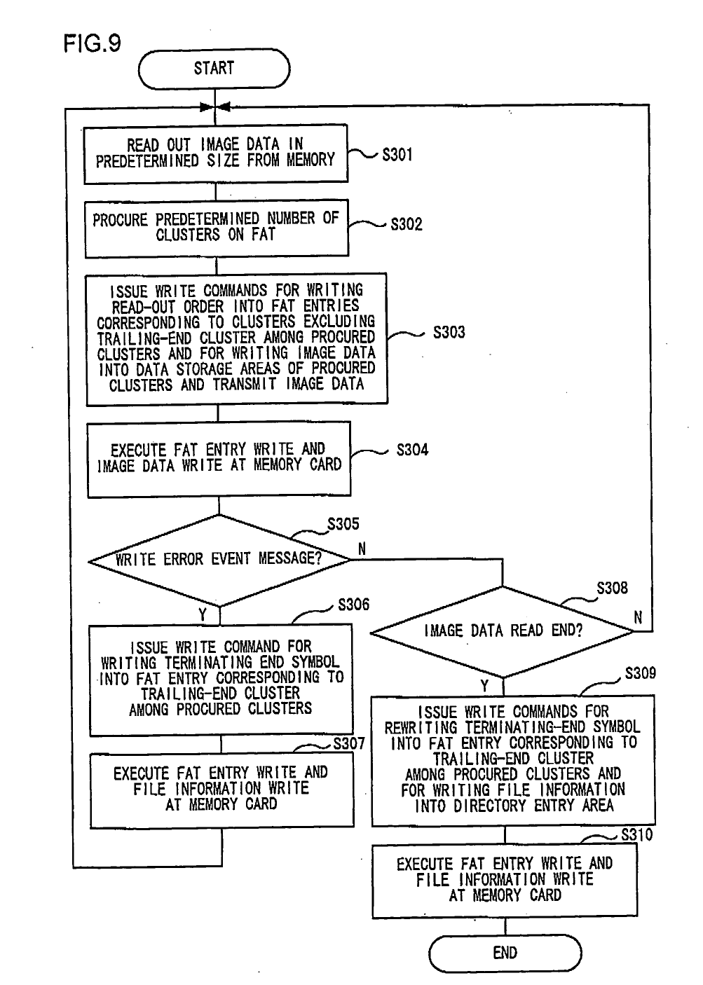

FIG. 9 presents a flowchart of the operation executed in the camera 1 in the variation. Steps S301˜S304 in FIG. 9 are identical to steps S201˜S204 in FIG. 4 executed prior to the image data write into the memory card 30. In addition, steps S308˜S310 in FIG. 9 are identical to steps S205˜S207 in FIG. 4, in which the image data write processing is executed without experiencing a write error while the image data write processing is in progress. For this reason, the processing executed in steps S301˜S304 and steps S308˜S310 is not explained in detail.

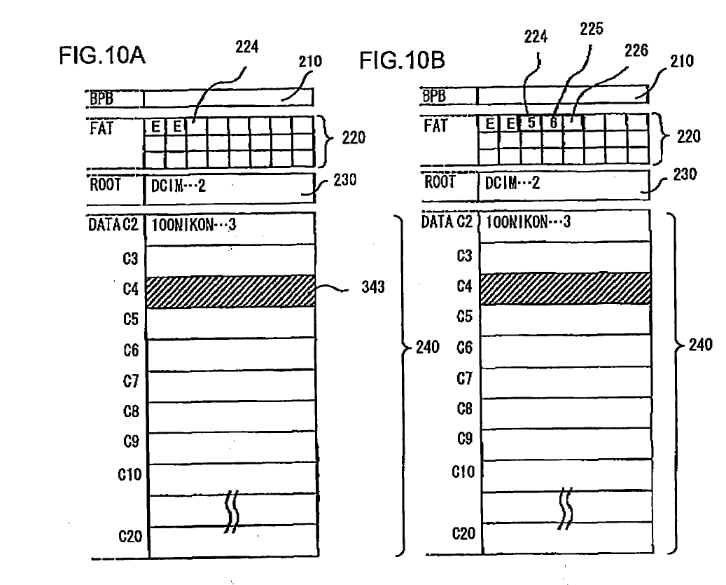

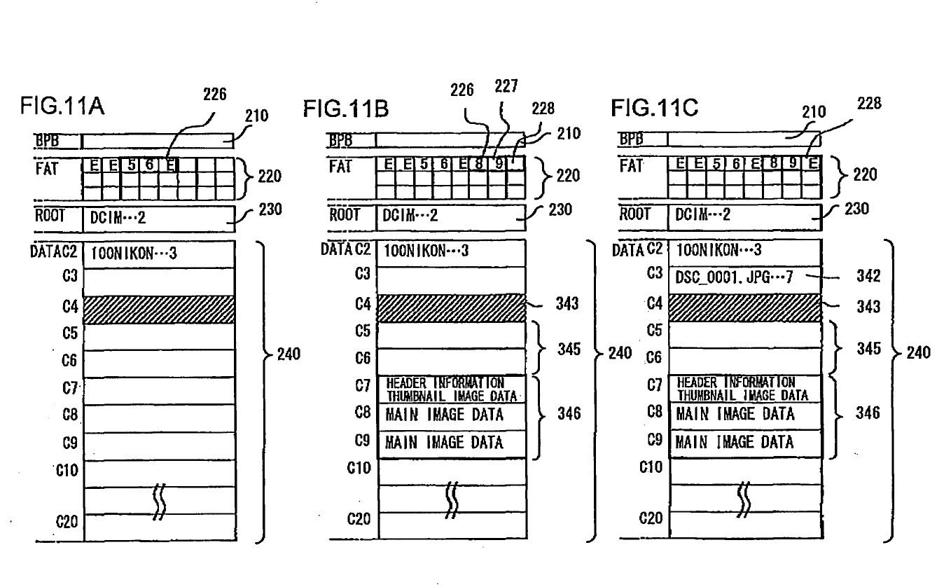

FIGS. 10A and 10B and FIGS. 11A˜11C present examples of conditions of the FAT filing system that may be assumed at various stages in the memory card 30 in the variation. Each figure shows the FAT filing system at a specific stage in a situation in which a write error occurs while image data in an image file are being recorded in a plurality of installments. The operation executed in the variation is now described in reference to the figures.

FIG. 10A shows the FAT filing system prior to image data recording. The description is given by assuming that while no data are stored in the FAT entry 224 of cluster 4, data are stored in the data storage area 343 of cluster 4.

The procuring functional unit 10b procures clusters 4˜6 as available areas by referencing the FAT 220 in FIG. 10A and procures the corresponding FAT entries. The read-out order write functional unit 10d writes the read-out order, i.e., cluster numbers “5” and “6”, in the FAT entries excluding the FAT entry corresponding to the trailing-end cluster 6, i.e., in the FAT entries corresponding to clusters 4 and 5 among the procured clusters. The read-out order write functional unit 10d then issues a write command for writing the read-out order in the FAT entries excluding the FAT entry corresponding to the trailing-end cluster 6, i.e. the FAT entries corresponding to clusters 4 and 5. The write functional unit 10c issues a write command for writing the image data read out from the memory 17 into the data storage areas of clusters 4˜6. In response to the write command, the read-out order is written (steps S301˜S304) in the FAT entries 224 and 225 in the memory card 30. FIG. 10B shows the FAT filing system following the processing in steps S301˜S304 executed as described above.

If the CPU 10 receives a write error event message response from the memory card 30 (step S305: Y) after the condition in FIG. 10B is assumed, the terminating end symbol write functional unit 10e issues a write command for writing the terminating end symbol “E” in the FAT entry corresponding to the trailing-end cluster 6 among the procured clusters (step S306). It is assumed that this write error has occurred as the memory card 30 has attempted to write the image data starting at the leading sector in the data storage area 343 of cluster 4 where data have already been recorded. The memory card 30, having received the write command via the memory card I/F 20, writes the terminating end symbol “E” in the FAT entry 226 corresponding to the trailing-end cluster 6 among the clusters having been procured and transmits a command response to the camera 1 (step S307). FIG. 11A shows the FAT filing system following the processing in steps S306 and S307 executed as described above after an affirmative decision has been made in step S305 (S305: Y).

The CPU 10 executes the processing in steps S301˜S304 explained earlier after step S307. Namely, the read functional unit 10a reads out the image data again from the memory 17 and the procuring functional unit 10b procures clusters in the FAT 220 again. Then, the read-out order write functional unit 10d issues a write command for writing the read-out order into the specific FAT entries among the FAT entries corresponding to the re-procured clusters. The write functional unit 10c issues a write command as a form of instruction for writing the image data into the procured clusters and transmits the image data. As in the first embodiment, the terminating end symbol write functional unit 10e issues a write command for writing the terminating end symbol in the FAT entry corresponding to the trailing-end cluster, among the re-procured clusters, when the read of the image data in the image file ends. In addition, the write functional unit 10c issues a write command for writing the file information into the directly entry area.

FIG. 11B shows the condition of the FAT filing system following the image data are rewritten by re-procuring clusters following the error event. As shown in the figure, no image data are recorded in the data storage areas 345 for clusters 5 and 6 at the memory card 30. The memory card 30 records cluster numbers “8” and “9” into FAT entries 226 and 227, excluding a FAT entry 228 corresponding to the trailing-end cluster 9 among the re-procured clusters, and records the image data into the data storage areas corresponding to clusters 7 through 9. FIG. 11C shows the condition of the FAT filing system when the read functional unit 10a ends the image data read. As shown in FIG. 11C, the terminating end symbol “E” is recorded in the FAT entry 228 corresponding to the trailing-end cluster 9 among the re-procured clusters and the file information indicating the image file name “DSC_{—}0001.JPG” and the starting cluster member “7” is recorded in the data storage area 342 of cluster 3 at the memory card 30.

In the first variation described above, even if image data are not written in the data storage area of a cluster where no error has occurred among the procured clusters, new available areas are procured without rewriting image data into the particular storage area. As a result, no FAT/data storage area mismatch occurs immediately after the occurrence of the error. In addition, since the file information indicating the image file name and the starting cluster is written at the end of the image file write, the file name remaining unchanged from that assumed before the occurrence of the write error, can be set for the image file when rewriting the image data following the occurrence of the write error.

Second Variation

The second variation of the embodiment is now described. In this variation, error processing different from that executed in the first variation is executed in the event of a write error in the memory card 30. It is to be noted that components identical to those in the first embodiment are referred to by quoting the same reference numerals. In addition, the variation is described by assuming that in the event of a write error in the memory card 30, the memory card 30 transmits a write error event message that includes the cluster number assigned to the error cluster where the write error has occurred, to the camera 1.

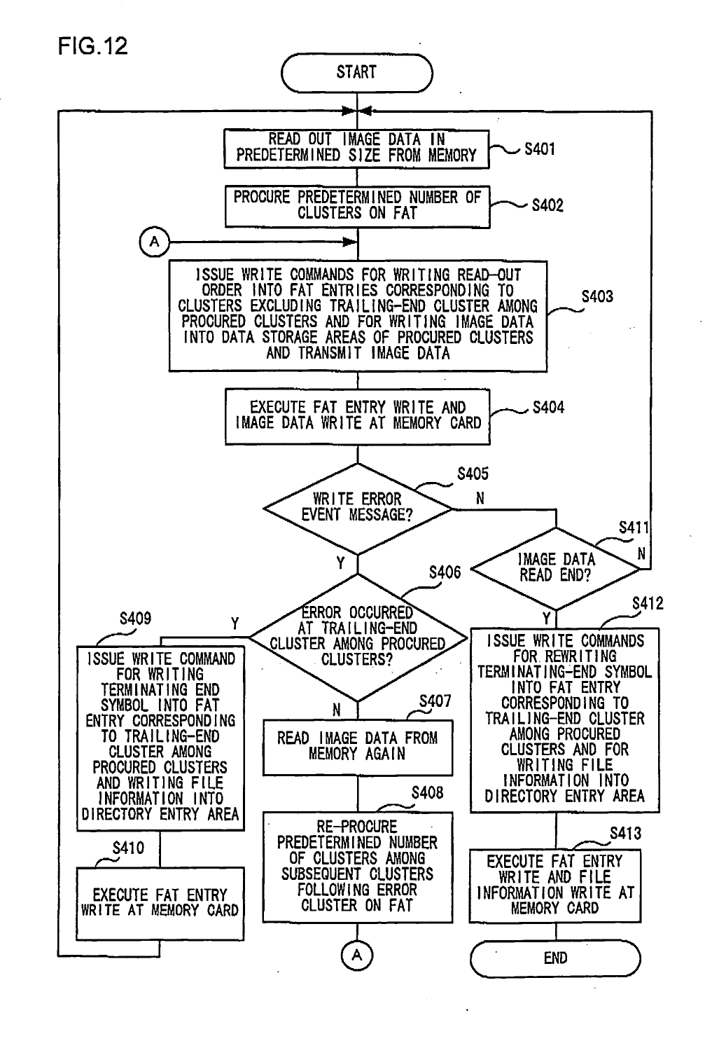

FIG. 12 presents a flowchart of the operation executed in the camera 1 in the variation. It is to be noted that steps S401˜S404 in FIG. 12 executed prior to the image data write into the memory card 30 are identical to steps S201˜S204 in FIG. 4. In addition, steps S411˜S413 in FIG. 12 are identical to steps S205˜S207 in FIG. 4, in which the image data write processing is executed without experiencing a write error while the image data write processing is in progress. For this reason, the processing executed in steps S401˜S404 and steps S411˜S413 is not explained in detail.

If the CPU 10 decides in step S405 that a write error event message originating from the memory card 30 has been received (step S405: Y), the CPU 10 makes a decision as to whether or not the error cluster number included in the error event message matches the cluster number assigned to the trailing-end cluster among the procured clusters (step S406). It is to be noted that the error, the occurrence of which is detected in step S405, will have occurred as the memory card 30 attempted to write image data into the data storage area of the cluster specified in the write command issued by the write functional unit 10c in step S403, where other data had actually been stored.

If it is decided that the error cluster number does not match the cluster number assigned to the trailing-end cluster (step S406: N), the read functional unit 10a reads out the image data (data segment) from the memory 17 again (step S407). The procuring functional unit 10b re-procures, in the FAT 220, clusters making up a single write unit, starting with the cluster immediately following the error cluster (step S408) and executes the processing in step S403 and subsequent steps.

If, on the other hand, the CPU decides that the error cluster number matches the cluster number assigned to the trailing-end cluster among the procured clusters (step S406: Y), the terminating end symbol write functional unit 10e issues a write command for writing the terminating end symbol in the FAT entry corresponding to the trailing-end cluster among the procured clusters (step S409). In conformance to the write command issued by the camera 1, the memory card 30 writes the terminating end symbol in the FAT entry corresponding to the trailing-end cluster (step S410). The CPU 10 then executes the processing in step S401 and subsequent steps.

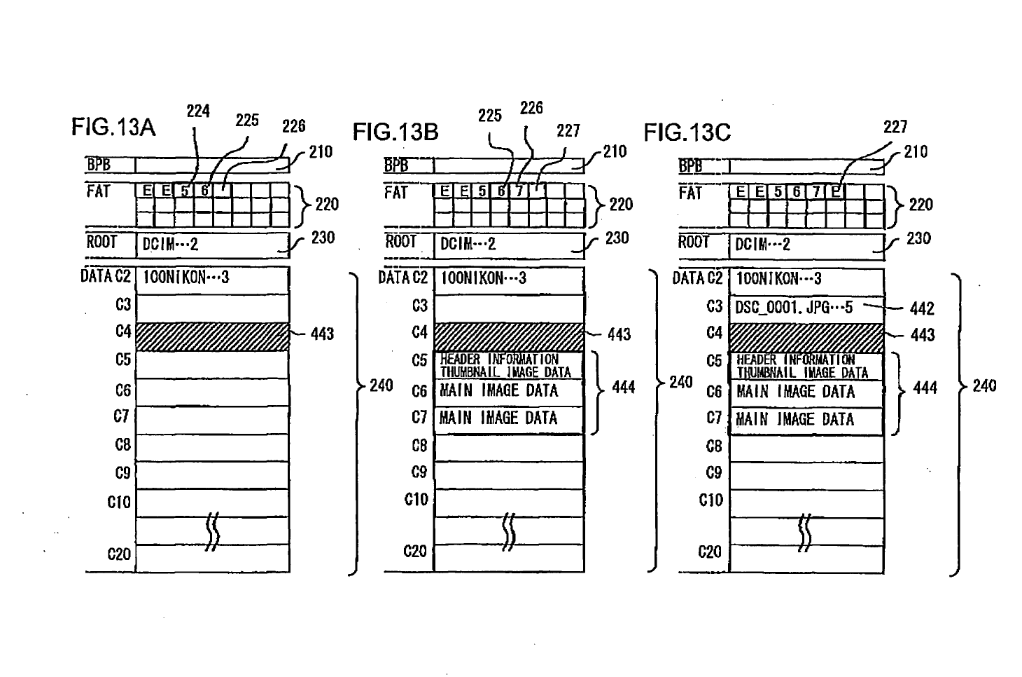

FIGS. 13A˜13C present examples of conditions that may be assumed in the FAT filing system in the memory card 30 in the variation. The conditions shown in the figures are described below by referring to the error processing executed in the individual steps in the variation. It is to be noted that the circumstances under which the FAT filing system assumes the conditions shown in FIGS. 13A˜13C are similar to those under which the FAT filing system assumes the conditions shown in FIGS. 10A and 10B in reference to which the first variation has been described. Namely, the procuring functional unit 10b procures clusters 4 through 6 (FAT entries 224˜226) in the FAT 220 and allocates image data to the clusters, and a write error occurs while the image data write into the data storage area 443 of cluster 4 is in progress at the memory card 30.

FIG. 13A shows the condition of the FAT filing system when the write error event message including the error cluster number “4” is transmitted from the memory card 30. As shown in the figure, the error cluster 4 is not the trailing-end cluster among the procured clusters (step S406: N) and accordingly, the read functional unit 10a reads out the image data from the memory 17 again (step S407). The procuring functional unit 10b then re-procures clusters 5 through 7 (FAT entries 225˜227) following the error cluster 4 in the FAT 220 (step S408). Next, in response to write commands, cluster number “7” is recorded (steps S403, S404) in the FAT entry 226 corresponding to cluster 6 at the memory card 30 and the image data are recorded in the data storage areas 444 of re-procured clusters 5˜7 at the memory card (steps S405, S406, S407: N, S413), as shown in FIG. 13B.

FIG. 13C shows the condition of the FAT filing system assumed when the image data read from the memory 17, executed in the condition shown in FIG. 13B, ends. As shown in the figure, the terminating end symbol “E” is recorded in the FAT entry 227 corresponding to the trailing-end cluster 7 among the re-procured clusters at the memory card 30. In addition, the file information indicating the image file name “DSC_{—}0001.JPG” and the starting cluster number “5” is recorded in the data storage area 442 of cluster 3 designated as the directory entry area at the memory card 30 (step S411: Y, steps S412 and S413).

As long as the error cluster where a write error occurs while an image data write into the memory card 30 is in progress, is not the trailing-end cluster among the procured clusters, the image data can be allocated to clusters corresponding to the write unit, procured starting with the cluster immediately following the error cluster in the variation. Thus, compared with procuring a new set of clusters corresponding to the write unit regardless of the location of the error, the extent of cluster wastage is minimized.

### Second Embodiment

In reference to drawings, a camera that includes the storage control device achieved in the second embodiment of the present invention is described. The following explanation focuses on the differences from the first embodiment by assigning the same reference numerals to components identical to those in the first embodiment. The essential components constituting the camera 1 in the second embodiment are similar to those of the camera 1 in the first embodiment shown in FIG. 1. In addition, the operation executed in the camera 1 in the second embodiment is similar to the operation executed in the camera 1 in the first embodiment, as shown in FIG. 3. Unless specifically noted, other aspects of the second embodiment are identical to those of the first embodiment. The second embodiment differs from the first embodiment in the record processing executed in step S18 in FIG. 3.

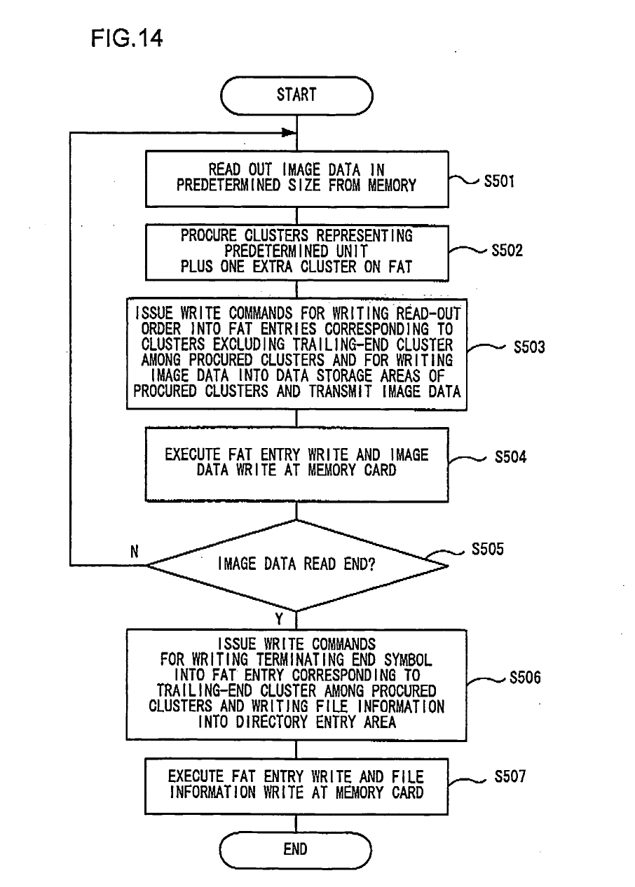

FIG. 14 presents a flowchart of the record processing executed in step S18. The following description is given by assuming that the data write unit assumed in the memory card 30 is smaller than the storage capacity of the memory 17 and that a single frame of image data is recorded into the memory card 30 in a plurality of installments.

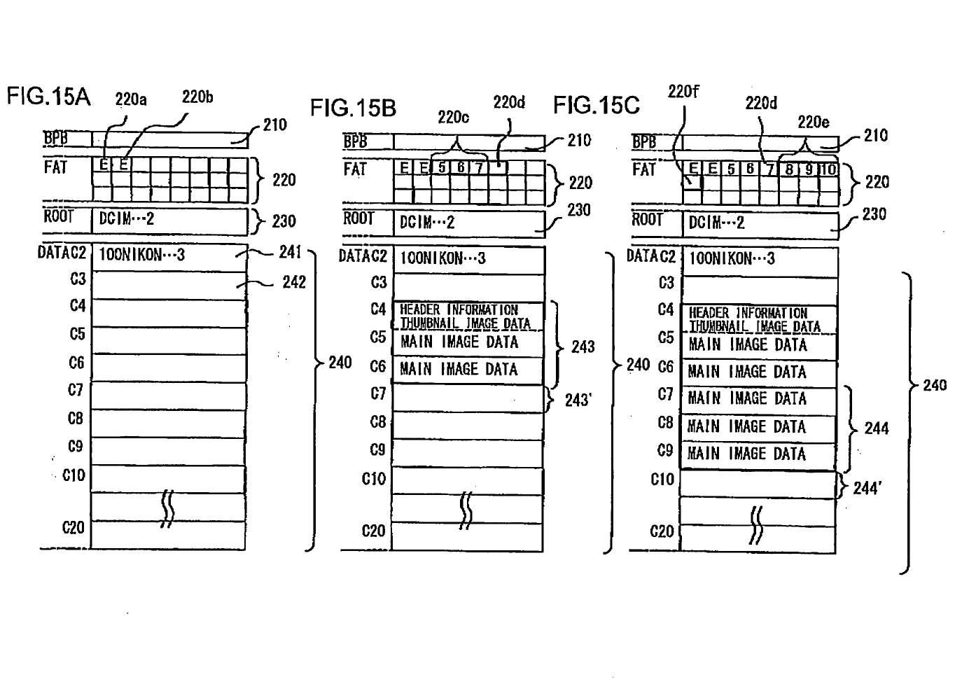

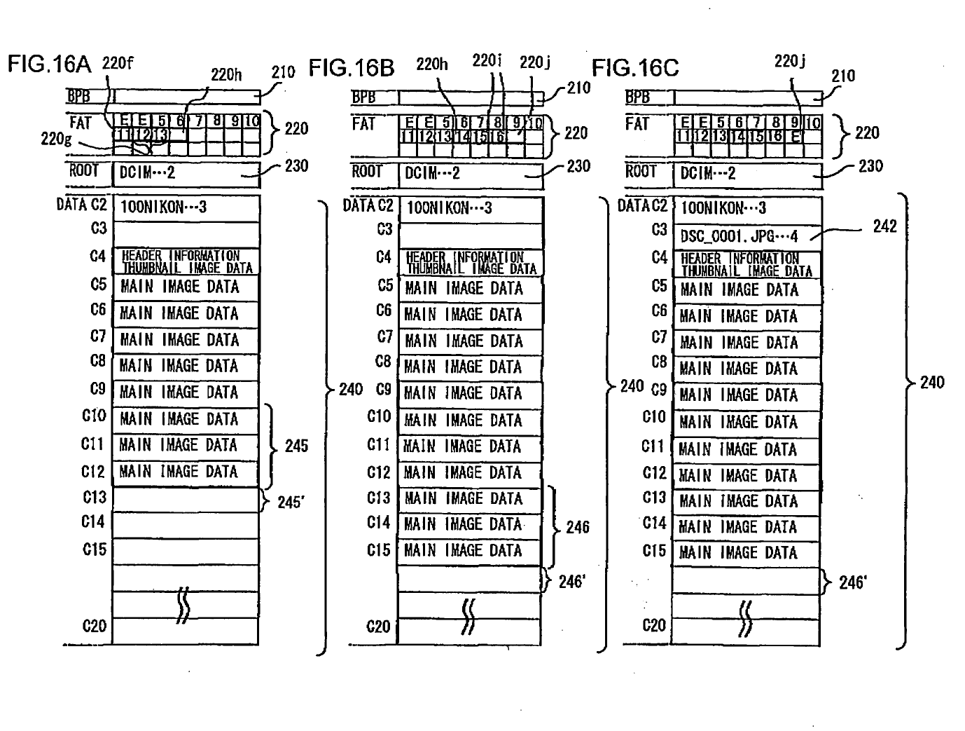

The decision-making functional unit 10f determines, based upon the card attribute information obtained in step S13, that the memory card 30 is a write-once type medium. The read functional unit 10a reads out from the memory 17 image data (data segment) corresponding to three clusters constituting a single write unit by referencing the write unit indicated in the card attribute information (step S501). FIGS. 15A˜15C and FIGS. 16A˜16C present examples of conditions of the FAT filing system in various stages, from the pre-record state, in which the image file is yet to be recorded into the memory card 30, through the state in which the data in the image file have been recorded in four separate installments. The following is a description of the various steps in FIG. 14, given in reference to FIGS. 15A˜15C and FIGS. 16A˜16C.

FIG. 15A shows the FAT filing system having been read out in step S501. The FAT filing system shown in FIG. 15A is similar to the FAT filing system in FIG. 5A in that a “DCIM” and cluster number “2” assigned to the cluster in which the subdirectory directly under the DCIM is stored, are stored in ROOT 230. In addition, the subdirectory “100 NIKON” having been generated in compliance with the DCF standard and cluster number “3” are stored in a data storage area 241 of cluster 2, in which the sub directory directly under DCIM is stored. Cluster number “3” indicates the directory entry area where the file information related to the image file stored under 100 NIKON is stored. In addition, the terminating end symbol “E” is stored in the FAT entries 220a and 220b corresponding to cluster 2 and cluster 3. It is to be noted that the second embodiment is described by assuming that the image file read out from the memory 17 is recorded directly under the subdirectory “100 NIKON”. File information indicating the filename of the image file and the starting cluster among the clusters in which the file is stored is recorded in the data storage area 242 of cluster 3 designated as the directory entry area.

The procuring functional unit 10b references the FAT 220 in FIG. 15A and procures four clusters 4˜7, i.e., three clusters making up the write unit plus an extra cluster. The read-out order write functional unit 10d then sequentially allocates image data, the volume of which matches three clusters, to the procured clusters 4˜6 and sets the immediately following cluster numbers in the FAT entries excluding the FAT entry of cluster 7, i.e., in the FAT entries corresponding to clusters 4˜6, so as to indicate the read-out order (step S502). It is to be noted that when procuring clusters in the FAT 220, the procuring functional unit 10b ensures that the FAT entries of the procured clusters are consecutive FAT entries in which no read-out order or terminating end symbol is stored.

The read-out order write functional unit 10d issues a write command. In response to this write command, the read-out order is written in the FAT entries except for the FAT entry corresponding to the trailing-end cluster 7, i.e., in the FAT entries corresponding to clusters 4˜6, among the procured clusters. The write functional unit 10c issues a write command for writing the image data having been read out in step S501 into the individual data storage areas of clusters 4˜6. The write functional unit 10c then transmits the image data having been readout to the memory card 30 (step S503).

Upon receiving the write commands and the image data via the memory card I/F 20, the memory card 30 transmits a command response to the camera 1. Based upon the received write commands, the memory card 30 writes the read-out order in the FAT entries and writes the image data sequentially starting at the leading sector in the data storage area corresponding to cluster 4. Subsequently, the memory card 30 transmits a data response via the memory card I/F 20 (step S504).

FIG. 15B shows the condition of the FAT filing system in the memory card 30 following the first image data read from the memory 17 (step S501) and the processing in steps S502˜S504 executed as described above. As shown in the figure, the immediately following cluster numbers “5”, “6” and “7” indicating the read-out order are recorded in the FAT entries 220c excluding the FAT entry 220d corresponding to the trailing-end cluster 7 among the procured clusters, i.e., in the FAT entries 220c corresponding to clusters 4˜6, at the memory card 30. The image file header information and thumbnail image data are recorded in the data storage area 243 of cluster 4, whereas part of the main image data in the image file is recorded into data storage areas 243 of clusters 5 and 6 at the memory card 30. It is to be noted that while the data storage area 243′ of cluster 7 is procured for the first data read, no data are recorded in the data storage area at this point.

As long as the read of the image data in the memory 17 by the read functional unit 10a is underway (step S505: N), the CPU 10 repeatedly executes the processing in steps S501˜S504. For each image data read session, the procuring functional unit 10b procures the FAT entries corresponding to four clusters, i.e., three clusters making up the write unit plus an extra cluster. The read-out order write functional unit 10d issues a write command as a form of instruction for writing the read-out order in the FAT entries corresponding to specific clusters among the procured clusters The write functional unit 10c transmits main image data, the volume of which matches three clusters making up the write unit.

FIG. 15C shows the condition of the FAT filing system following the second image data read executed with the FAT filing system in the condition shown in FIG. 15B, the data write into FAT entries and the image data write into data storage areas. As shown in the figure, as the second image data read session is executed, clusters 7˜10 are procured and the memory card 30 records the read-out order in the FAT entries 220d and 220c, excluding the FAT entry 220f corresponding to the trailing-end cluster 10 among the procured clusters. The memory card 30 also records the main image data into the data storage areas 244 of clusters 7˜9, i.e., into the data storage areas excluding the data storage area 244′ of cluster 10.

FIG. 16A shows the condition of the FAT filing system following the third image data read is executed with the FAT filing system in the condition shown in FIG. 15C, the data write into FAT entries and the image data write into data storage areas. As shown in the figure, as the third image data read session is executed, clusters 10˜13 are procured and the memory card 30 records the read-out order in the FAT entries 220f and 220g, excluding the FAT entry 220h corresponding to the trailing-end cluster 13 among the procured clusters. The memory card 30 also records the main image data into the data storage areas 245 of clusters 10˜12, i.e., into the data areas excluding the data storage area 245′ of cluster 13.

FIG. 16B shows the condition of the FAT filing system following the fourth image data read is executed with the FAT filing system in the condition shown in FIG. 16A, the data write into FAT entries and the image data write into data storage areas. As the fourth image data read session is executed, clusters 13˜16 are procured and the memory card 30 records the read-out order in the FAT entries 220h and 220i, excluding the FAT entry 220j corresponding to the trailing-end cluster 16 among the procured clusters. The memory card 30 also records the main image data into the data storage areas 246 of clusters 13˜15, i.e., into the data areas excluding the data storage area 246′ of cluster 16.

When the read of the image data in the image file from the memory 17 by the read functional unit 10a ends (step S505: Y) in the processing shown in FIG. 14, the write functional unit 10c in the CPU 10 issues a write command for writing the terminating end symbol in the FAT entry corresponding to the trailing-end cluster 16 among the clusters having been procured last. The terminating end symbol write functional unit 10e issues a write command for writing file information indicating the image file name “DSC_{—}0001.JPG” and the image file starting cluster number “4” into the data storage area of cluster 3 (step S506). The write commands issued in step S506 are received at the memory card 30 via the memory card I/F 20. The memory card 30 then transmits a command response via the memory card I/F 20. In conformance to the received write commands, the terminating end symbol is written in the FAT entry corresponding to cluster 16 and the file information indicating the file name “DSC_{—}0001.JPG” and the starting cluster number “4” is written into the data storage area of cluster 3 at the memory card 30. The memory card 30 then transmits a data response via the memory card I/F 20 (step S507).

FIG. 16C shows that the FAT filing system assumes the condition in which after the FAT filing system assumes the condition shown in FIG. 16B, the image data read from the memory 17 ends and the processing in steps S506 and S507 is executed. As shown in the figure, the terminating end symbol “E” is recorded in a FAT entry 220j corresponding to the trailing-end cluster 16 and the file information indicating the image file name “DSC_{—}0001.JPG” and the starting cluster number “4” is recorded in the data storage area 242 of cluster 3 at the memory card 30.

In the second embodiment described above, as data into predetermined size are read out from the memory, one extra cluster is procured in addition to the number of clusters needed to write the data in the predetermined size having been read out. Until the write of the entire file is completed, no data are written in the FAT entry corresponding to the extra cluster procured in correspondence to each data read session. Thus, data can be continuously written until the entire data write is completed and the data in the file can be written in a plurality of installments.

In addition, while the terminating end symbol is recorded in the FAT entry corresponding to the trailing-end cluster among the most recently procured clusters when the data write processing ends, the write processing is terminated without recording any data into the data storage area of the particular cluster in the second embodiment. Thus, the data storage area in the cluster will be wasted. However, the FAT entry and the data storage area corresponding to each cluster is controlled so as to assume matching data storage states. As a result, even if interrupt processing such as disengagement of the memory card occurs while the record processing is in progress, the orderly storage condition within the file system is not disrupted.

Next, variations of the second embodiment explained above are described.

Third Variation

The second embodiment is described above by assuming that no write error occurs while the write of image data into the memory card 30 is in progress. Now, in reference to this particular variation, error processing that may be executed after a write error occurs in the memory card 30 is described. It is to be noted that components identical to those described in the embodiment are referred to by quoting the same reference numerals. In addition, the variation is described by assuming that in the event of a write error in the memory card 30, the memory card 30 transmits a write error event message to the camera 1.

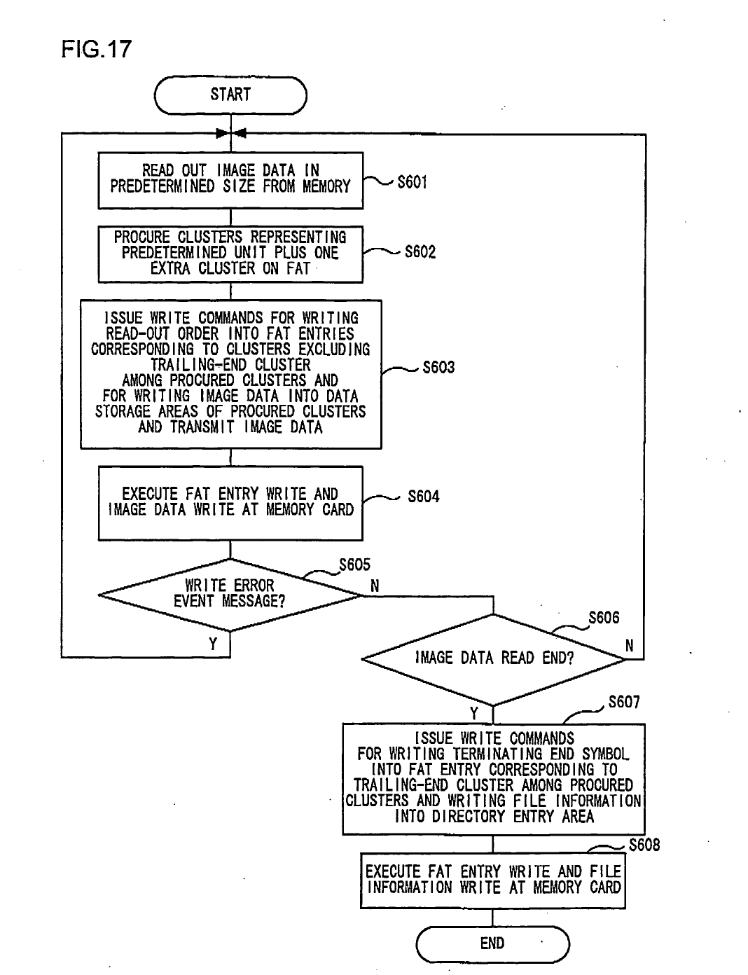

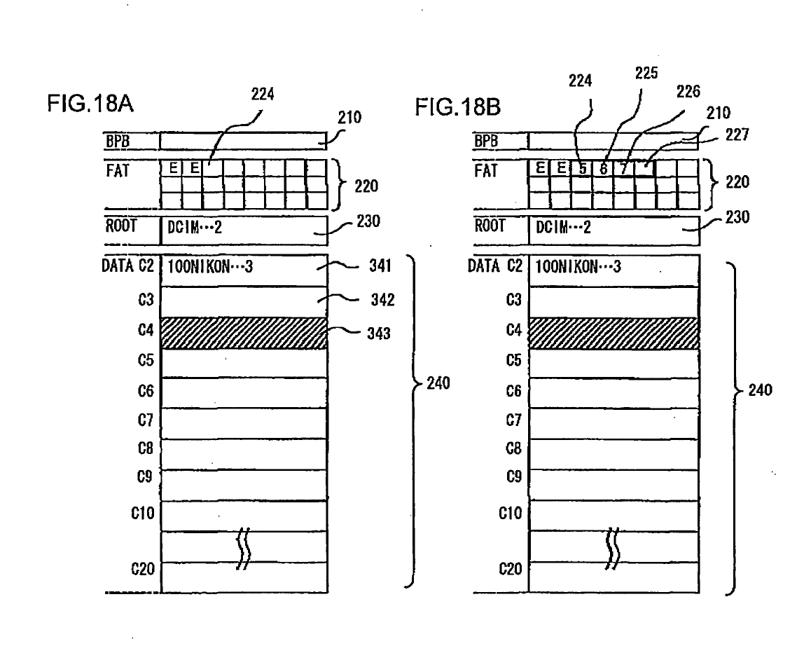

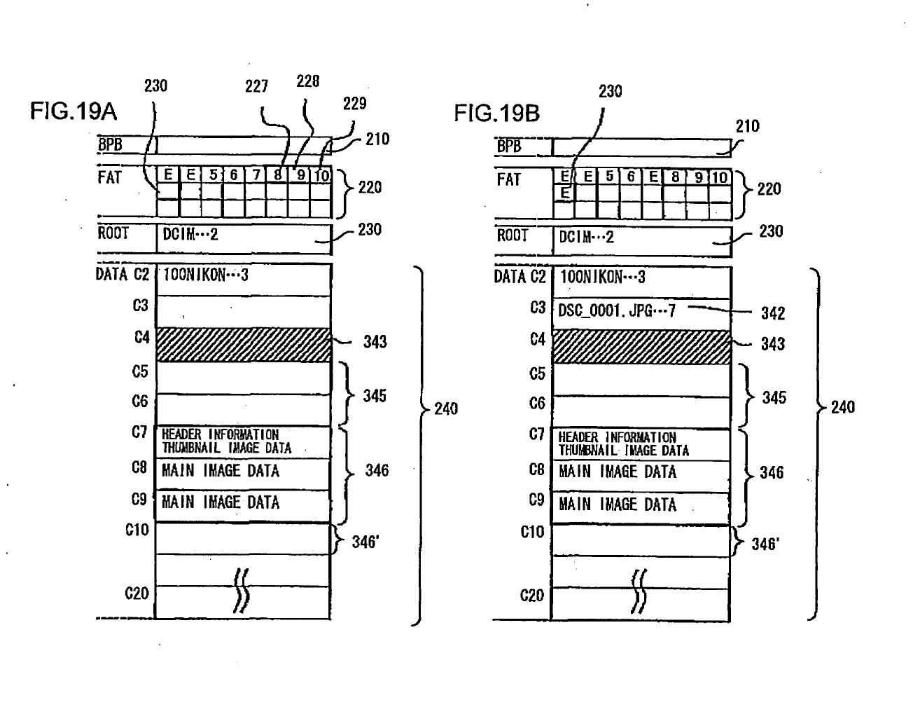

FIG. 17 presents a flowchart of the operation executed in the camera 1 in the variation. Steps S601˜S604 in FIG. 17 are identical to steps S501˜S504 in FIG. 14 executed prior to the image data write into the memory card 30. In addition, steps S606˜S608 in FIG. 17 are identical to steps S505˜S507 in FIG. 14, in which the image data write processing is executed without experiencing a write error while the image data write processing is in progress. For this reason, the processing executed in steps S601˜S604 and steps S606˜S608 is not explained in detail. FIGS. 18A and 18B and FIGS. 19A and 19B present examples of conditions of the FAT filing system that may be assumed in the memory card 30 in the variation. The operation executed in the variation is now described in reference to the figures.

FIG. 18A shows the condition of the FAT filing system prior to image data recording. In the filing system in FIG. 18A, no read-out order or terminating end symbol is stored in the FAT entry 224 corresponding to cluster 4 but data are stored in the data storage area 343 for cluster 4 and thus, the filing system is in a state of disarray.

FIG. 18B shows the condition of the FAT filing system assumed after the read functional unit 10a reads out image data, the volume of which matches three clusters, making up the write unit, from the memory 17 (step S601), the procuring functional unit 10b procures clusters 4˜7 by referencing the FAT 220 in FIG. 18A, a write command is issued by the read-out order write functional unit 10d and a write command is issued by the functional unit 10c. In response to the write commands, the read-out order is written in the FAT entries corresponding to clusters 4 and 5 having been procured and the image data having been read out are written into the data storage areas of the procured clusters 4˜6. As shown in the figure, the read-out order is recorded in the FAT entries 224˜226 excluding the FAT entry 227 corresponding to the trailing-end cluster 7 among the procured clusters at the memory card 30 (steps S601˜S604). Under these circumstances, a write error occurs if the memory card attempts to write image data into the data storage area 343 of cluster 4, starting at the leading sector in the data storage area, where data are already recorded.

As the CPU 10 receives a write error event message response from the memory card 30 (step S605: Y) in the processing shown in FIG. 17, the read functional unit 10a reads out image data, the volume of which matches three clusters, making up the write unit again from the memory 17 (step S601). The procuring functional unit 10b references the FAT 220 in FIG. 18B and re-procures four clusters, i.e., one extra cluster in addition to the three clusters making up the write unit, selected from clusters including and succeeding the trailing-end cluster 7 having been procured immediately before the occurrence of the write error (step S602). The memory card 30 then records data in the FAT entries and the data storage areas corresponding to the re-procured clusters (steps S603 and S604).

FIG. 19A shows the condition of the FAT filing system assumed after the processing in steps S601˜S604 is executed as described above following the occurrence of error. As shown in the figure, clusters 7˜10 including the trailing-end cluster 7 having been procured prior to the occurrence of the error are re-procured. The read-out order “8˜10” is recorded in the FAT entries 227˜229, excluding the FAT entry 230 corresponding to cluster 10, i.e., in the FAT entries 227˜229 corresponding to clusters 7˜9. The image data having been read out again are rewritten into the data storage areas 346 of clusters 7˜9.

When the read of the image data in the image file by the read functional unit 10a ends, i.e., when the image file write ends (step S606:Y) in the processing shown in FIG. 17, the terminating end symbol write functional unit 10e writes the terminating end symbol in the FAT entry corresponding to the trailing-end cluster among the procured clusters and the write functional unit 10c writes the file information into the directory entry area (steps S607, S608). FIG. 19B shows the condition of the FAT filing system assumed as the image data read ends and the image file write ends. As shown in the figure, the terminating end symbol “E” is recorded in the FAT entry 230 corresponding to the trailing-end cluster 10 and the file information indicating the image file name “DSC_{—}0001.JPG” and the cluster number “7”, assigned to the cluster at which the write was resumed, is recorded in the data storage area 342 of cluster 3. As a result, data storage areas 345 of clusters 5 and 6 having been procured immediately before the occurrence of the error and the data storage area 346′ of the trailing-end cluster 10 procured at the end of the image data read end do not hold any data recorded therein.

In the third variation described above, no read-out order or terminating end symbol is recorded in the FAT entry corresponding to the trailing-end cluster, i.e., the extra cluster procured for each read session. As a result, in the event of a write error, error processing can be executed by resuming the data write at the trailing-end cluster among the clusters having been procured immediately before the occurrence of the error. Thus, even in the event of a write error, interrupt processing or the like, the cluster area procured as an extra in correspondence to each data read session can be utilized fully without causing any disruption in the orderly state of the filing system. In addition, the same file name, unchanged from that set before the occurrence of the error, can be set for the data, the write of which resumes after the occurrence of the write error, by writing the file information indicating the image file name and the starting cluster when the image file write is completed.

Fourth Variation

The fourth variation of the embodiment is now described. In this variation, error processing different from that executed in the third variation is executed in the event of a write error in the memory card 30. It is to be noted that components identical to those in the embodiment are referred to by quoting the same reference numerals. In addition, the variation is described by assuming that in the event of a write error in the memory card 30, the memory card 30 transmits a write error event message that includes the error cluster number assigned to the error cluster where the write error has occurred, to the camera 1.

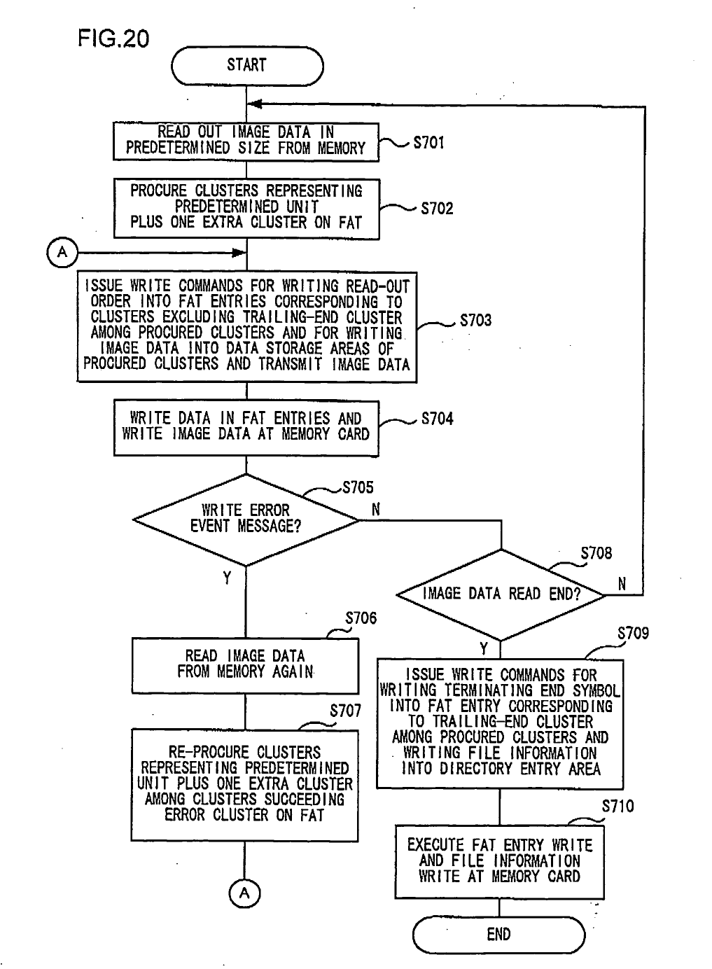

FIG. 20 presents a flowchart of the operation executed in the camera 1 in the variation. Steps S701˜S704 in FIG. 20 executed prior to the occurrence of the error at the memory card 30 are identical to steps S505˜S507 in FIG. 14. Steps S708˜S710 are identical to steps S505˜S507 in FIG. 14, in which the image data write processing is executed without experiencing a write error while the image data write processing is in progress. For this reason, the processing executed in steps S701˜S704 and steps S708˜S710 is not explained in detail.

As is the third variation described above, the fourth variation is described by assuming that the CPU 10 receives a write error event message from the memory card 30 (step S705: Y). It is assumed that the error indicated in the write error event message has occurred as the memory card 30 has attempted to write image data into the data storage area in the cluster specified by the write command having been issued by the CPU 10, where data are already stored.

In this variation, the read functional unit 10a reads image data again from the memory 17 (step S706). The procuring functional unit 10b re-procures four clusters, i.e., one extra cluster in addition to the three clusters making up the write unit, selected from clusters succeeding the error cluster in the FAT (step S707) and then the CPU 10 executes the processing in steps S703 and S704.

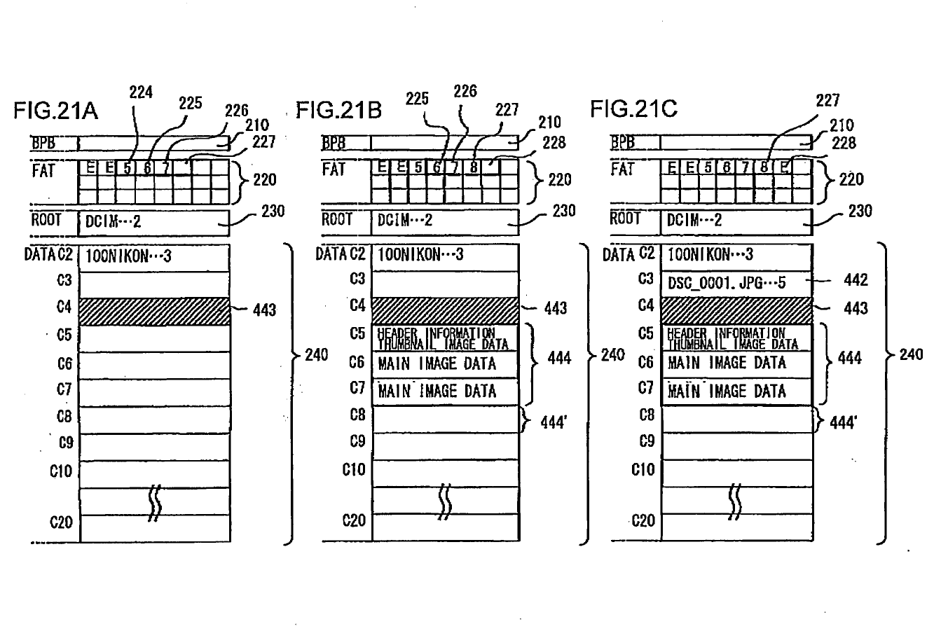

FIGS. 21A˜21C present examples of conditions that may be assumed in the FAT filing system in the memory card 30 in the variation. As assumed with regard to the conditions shown in FIGS. 18A and 18B in reference to which the third variation has been described, that clusters 4˜7 having been procured in the FAT and that a write error has occurred in the data storage area 443 of cluster 4 at the memory card 30. The following is a step-by-step description of the error processing executed in the variation, given in reference to the drawings.

FIG. 21A shows the condition of the FAT filing system assumed as the memory card 30 transmits a write error event message including the error cluster number “4”. As shown in the figure, clusters 4˜7 are procured in the FAT and the read-out order is recorded in the FAT entries 224˜226 corresponding to clusters 4˜6.

FIG. 21B shows the condition of the FAT filing system assumed after the error processing for the write error having occurred in the data storage area 443 of cluster 4 is executed. As shown in the figure, the FAT entries 225˜228 corresponding to clusters 5˜8 succeeding the error cluster 4 are re-procured in the FAT 220 (step S707), so as to accommodate the image data, the volume of which matches three clusters, having been read out again following the issuance of the write error event message. The memory card 30 then records the read-out order in the FAT entry 227 among the FAT entries 225˜227 corresponding to clusters 5˜7 excluding the FAT entry 228 corresponding to cluster 8. At the memory card assuming the condition shown in FIG. 21A no read-out order is recorded in the FAT entry 227. The image data, the volume of which matches three clusters, having been read out again, are rewritten (steps 703, S704) in the data storage areas 444 excluding the data storage area 444′ of cluster 8, i.e., in the data storage areas 444 of clusters 5˜7, at the memory card 30.

FIG. 21C shows the condition of the FAT filing system assumed when the image data read from the memory 17, executed in the state shown in FIG. 21B, ends. As shown in the figure, the terminating end symbol “E” is recorded in the FAT entry 228 corresponding to the trailing-end cluster 8 among the clusters procured at the end of the image data read-out again at the memory card 30. In addition, the file information indicating the image file name “DSC_{—}0001.JPG” and the starting cluster number “5” assigned to the cluster at which the write resumed, is recorded in the data storage area 442 of cluster 3 at the memory card 30 (step S708: Y, steps S709 and S710). Thus, as in the embodiment, the file write operation ends at the memory card 30 with no data recorded in the data storage area 444′ in the trailing-end cluster 8 among the most recently procured clusters.

In the event of a write error occurring while image data are being written into the memory card 30, the image data write can be resumed by re-procuring clusters selected from clusters succeeding the error cluster in the variation. Thus, as long as the write error does not occur at the last cluster in each set of three clusters making up the write unit, the number of wasted clusters can be reduced over the third variation.

It is to be noted that while the storage control device according to the present invention having been described in reference to the first and second embodiments and the first through fourth variations is included in a camera, the present invention may instead be adopted in an information device such as a portable telephone, a PDA unit or a PC, at which at least either a write-once-type storage medium or a non-write-once type storage medium can be loaded.

In addition, while an explanation is given above in reference to the embodiments and the variations on an example in which the file data recorded into the memory card are still image data compressed in the JPEG format, the file data recorded in the memory card may be image data in the TIFF format, raw image data, video image data or audio data.

The above described embodiments are examples and various modifications can be made without departing from the scope of the invention.

What is claimed is;

1. A storage control device, comprising:
a memory in which a data file is temporarily stored;
a read-out unit that sequentially reads out data segments obtained by dividing the data file stored in the memory into equal data segments matching a predetermined unit;
a storage medium that includes data storage areas made up with a plurality of small areas all assuming a predetermined size and a plurality of data management areas each corresponding to one of the plurality of small areas, so as to store each of the data segments into small areas and store at least one of first link information and second link information into the data management areas, the first link information indicating a read-out order with which the data segments stored in the small areas are to be read out and the second link information indicating an end of the read of the data segments;
a first instruction unit that issues an instruction for procuring a plurality of consecutive data management areas in correspondence to a data size of data segments having been read out by the read-out unit;
a second instruction unit that issues an instruction for writing the first link information into the data management areas excluding a trailing-end data management area among the procured data management areas; and
a third instruction unit that issues an instruction for sequentially writing the data segment having been read out by the read-out unit into the data storage areas corresponding to the procured data management areas.

2. A storage control device according to claim 1, further comprising:
a fourth instruction unit that issues an instruction for writing the second link information into the trailing-end data management area among the data management areas procured in correspondence to the data size of the data segment read out last among all the data segments in the data file.

3. A storage control device according to claim 1, further comprising:
a fourth instruction unit that issues an instruction for writing the second link information into the trailing-end data management area among the procured data management areas if a write error occurs while the data segment is being written into the data storage areas, wherein:
the read-out unit reads out the data file stored in the memory again in the data segments all matching the predetermined unit;
the first instruction unit issues an instruction for re-procuring the data management areas in correspondence to the data size of each data segment having been read out again;
the second instruction unit issues an instruction for writing the first link information into the data management areas excluding the trailing-end data management area among the re-procured data management areas; and
the third instruction unit issues an instruction for writing the data segment having been read again into the data storage areas corresponding to the re-procured data management areas.

4. A storage control device according to claim 3, wherein:
if a data storage area where the write error has occurred corresponds to the trailing-end data management area among the procured data storage areas, the fourth instruction unit issues an instruction for writing the second link information into the trailing-end data management area among the procured data management areas;
if the data storage area where the write error has occurred does not correspond to the trailing-end data management area among the procured data management areas;
the read-out unit reads out the data file stored in the memory again in the predetermined unit;
the first instruction unit issues an instruction for re-procuring the data management areas corresponding to data storage areas succeeding the data storage area where the write error has occurred;
the second instruction unit issues an instruction for writing the first link information into the data management areas excluding the trailing-end data management area among the re-procured data management areas; and
the third instruction unit issues an instruction for writing each data segment having been read out again into the data storage areas corresponding to the re-procured data management areas.

5. A storage control device according to claim 4, further comprising:
a fifth instruction unit that issues an instruction for recording a data file read-out start position at which read of the data file to be stored in the data storage areas starts, into a specific data storage area, wherein:
the fourth instruction unit issues an instruction for writing the second link information into the trailing-end data management area among the data management areas re-procured in correspondence to the data size of the last data segment having been read out again among all the data segments in the data file; and
the fifth instruction unit issues an instruction for writing into the specific data storage area information on the data storage area at which a write of the data segments having been read out again starts as information indicating the data file read-out start position.

6. A storage control device according to claim 1, further comprising:
a decision-making unit that makes a decision as to whether a storage medium is a write-once storage medium or a non-write-once-type storage medium and
a fourth instruction unit that issues an instruction for writing the second link information into the trailing-end data management area among the data management areas procured in correspondence to the data size of the data segment each time a data segment is read out, if a storage medium is judged to be a non-write-once storage medium.

7. A storage control device, comprising:
a memory in which a data file is temporarily stored;
a read-out unit that sequentially reads out data segments obtained by dividing the data file stored in the memory into equal data segments matching a predetermined unit;
a storage medium that includes data storage areas made up with a plurality of small areas all assuming a predetermined size and a plurality of data management areas each corresponding to one of the plurality of small areas, so as to store each of the data segments into small areas and store at least one of first link information and second information into the data management area, the first link information indicating a read-out order with which the data segments stored in the small areas are to be read out second link information indicating an end of the read of the data segments;
a first instruction unit that issues an instruction for procuring a plurality of consecutive data management areas in correspondence to a data size of data segments having been read out by the read-out unit and a subsequent data management area following the consecutive data management areas;
a second instruction unit that issues an instruction for writing the first link information in the data management areas excluding a trailing-end data management area among the procured data management areas; and
a third instruction unit that issues an instruction for sequentially writing the data segment, having been read out by the read-out unit into the data storage areas corresponding to the data management areas in which the first link information has been written, excluding the trailing-end data management area.

8. A storage control device according to claim 7, further comprising:
a fourth instruction unit that issues an instruction for writing the second link information into the trailing-end data management area among the data management areas procured for the data segment read out last among all the data segments in the data file.

9. A storage control device according to claim 8, further comprising:
a fifth instruction unit that issues an instruction for recording a data file read-out start position at which read of the data file to be stored in the data storage areas starts, into a specific data storage area, wherein:
if a write error occurs while write of the data segment into the data storage areas corresponding to the procured data management areas is in progress;
the read-out unit again reads out the data stored in the memory in the data segments all matching the predetermined unit;
the first instruction unit issues an instruction for re-procuring the data management areas following the trailing-end data management area among the data management areas having been procured immediately before occurrence of the write error;
the second instruction unit issues an instruction for writing the first link information into the data management areas excluding the trailing-end data management area among the re-procured data management areas;
the third instruction unit issues an instruction for executing rewrite processing for writing again each data segment read out again into the data storage areas corresponding to the data management areas in which the first link information is written, excluding the trailing-end data management area among the re-procured data management areas;
the fourth instruction unit issues an instruction for writing the second link information into the trailing-end data management area among the data management areas procured at an end of the rewrite processing executed for all the data segments in the data file; and
the fifth instruction unit issues an instruction for writing information on the data storage area at which the rewrite processing starts into the specific data storage area as information indicating the data file read-out start position.

10. A storage control device according to claim 8, further comprising:
a fifth instruction unit that issues an instruction for recording a data file read-out start position at which read of the data file to be stored in the data storage areas starts, into a specific data storage area, wherein:
if a write error occurs while write of the data segment into the data storage areas corresponding to the procured data management areas is in progress;
the first instruction unit issues an instruction for re-procuring the data management areas corresponding to the data storage areas succeeding a data storage area where the write error has occurred;
the second instruction unit issues an instruction for writing the first link information into the data management areas excluding the trailing-end data management area among the re-procured data management areas;
the third instruction unit issues an instruction for executing rewrite processing for writing again each data segment read out again into the data storage areas corresponding to the data management areas in which the first link information is written, excluding the trailing-end data management area among the re-procured data management areas;
the fourth instruction unit issues an instruction for writing the second link information into the trailing-end data management area among the data management areas procured at an end of the rewrite processing executed for all the data segments in the data file; and
the fifth instruction unit issues an instruction for writing information on the data storage area at which the rewrite processing starts into the specific data storage area as information indicating the data file read-out start position.

11. A storage control device according to claim 7, further comprising:
a decision-making unit that makes the decision as to whether a storage medium is a write-once-type storage medium or a non-write-once storage medium; and
a fourth instruction unit that issues an instruction for writing the second link information into the trailing-end data management area among the data management areas procured for each data segment that is read out, if the storage medium is judged to be a non-write-once type storage medium.
